(19) United States
(12) Patent Application Publication
(10) Pub. No.: US 2020/0342095 A1
(43) Pub. Date: Oct. 29, 2020

(54) RULE GENERATON APPARATUS AND COMPUTER READABLE MEDIUM

(71) Applicant: MITSUBISHI ELECTRIC CORPORATION, Tokyo (JP)

(72) Inventors: Hideaki IJIRO, Tokyo (JP); Kiyoto KAWAUCHI, Tokyo (JP); Takuya SHOYA, Tokyo (JP); Atsushi KATO, Tokyo (JP); Hiromitsu SHIRAI, Tokyo (JP); Hisashi FUKUDA, Tokyo (JP)

(73) Assignee: MITSUBISHI ELECTRIC CORPORATION, Tokyo (JP)

(21) Appl. No.: 16/960,727

(22) PCT Filed: Jun. 21, 2018
(86) PCT No.: PCT/JP2018/023568

§ 371 Date: Jul. 8, 2020

(30) Foreign Application Priority Data
Feb. 26, 2018 (JP) 2018-032092

(51) Int. Cl. G06F 21/55; G06F 16/28

(52) U.S. Cl. CPC G06F 21/55; G06F 2221/034; G06F 16/285

(57) ABSTRACT

A classification unit classifies, per attack log data of a plurality of pieces of attack log data, one or more pieces of log information included in the attack log data, by value set consisting of a value of a first element and a value of a second element, thereby generating one or more log information groups. An integration unit integrates, per log information group, one or more pieces of log information included in the log information group, thereby generating integrated data. An extraction unit extracts, per value set, in one or more value sets, that is common among the plurality of pieces of attack log data, common information from a plurality of pieces of integrated data corresponding to the plurality of pieces of attack log data. A generation unit generates one or more attack detection rules based on one or more pieces of common information.

### TECHNICAL FIELD

The present invention relates to a technique for generating an attack detection rule.

### BACKGROUND ART

In a cyber attack, various attacking activities such as brute force attack using log-in passwords and unauthorized privilege escalation are performed.

In security monitoring, a detection rule is created to detect traces of these attacking activities. Then, it is analyzed whether a log occurring in an information system, alert information produced by a security product, and so on meet the detection rule. When an incident that meets the detection rule occurs, an alert is notified to an operator and the incident is handled.

As new techniques for attacking activities are discovered day after day, creation of the detection rule must be performed continuously.

In order to create the detection rule, it is necessary to specify where and in what manner a trace of an attacking activity remains on a monitored target.

However, identification of a trace requires high-level security knowledge, and it is difficult to create a detection rule for an operator with only general knowledge.

Patent Literature 1 discloses a technique of creating a detection rule for detecting a feature of an attack from a log.

According to this technique, a common feature is extracted from logs obtained based on execution results of a plurality of pieces of malware, and a tentative detection rule is created. Then, a number of erroneous detections for normal software is measured with using the tentative detection rule, and whether or not the tentative detection rule is to be adopted is decided according to the number of erroneous detections.

### CITATION LIST

### Patent Literature

Patent Literature 1: JP 2013-092981 A

### SUMMARY OF INVENTION

### Technical Problem

With the technique disclosed in Patent Literature 1, it is not possible to extract a feature that is common among attacks. Specifically, a number of times of appearance, cyclicity, and so on cannot be extracted. For example, a large amount of accesses by normal users to a specific destination cannot be extracted as a feature.

Also, due to a change in a parameter according to an environment or a condition, a feature that is not an essential feature of an attack may be extracted. For example, in order to create a detection rule about an attack of a large amount of accesses to a specific destination, a large amount of accesses are made to a specific terminal A in an information system, and logs are collected. In this case, the essential feature of the attack is “to make a large amount of accesses regardless of a destination terminal”. However, there is a possibility that an erroneous feature “to make a large amount of accesses to the terminal A” is extracted.

An objective of the present invention is to make it possible to generate an attack detection rule based on information that is common among a plurality of pieces of attack log data.

### Solution to Problem

A rule generation apparatus according to the present invention includes: a classification unit to classify, per attack log data of a plurality of pieces of attack log data, one or more pieces of log information included in the attack log data, by value set consisting of a value of a first element and a value of a second element, thereby generating one or more log information groups;
an integration unit to integrate, per log information group, one or more pieces of log information included in the log information group, thereby generating integrated data;

an extraction unit to extract, per value set, in one or more value sets, that is common among the plurality of pieces of attack log data, common information from a plurality of pieces of integrated data corresponding to the plurality of pieces of attack log data; and

a generation unit to generate one or more attack detection rules based on one or more pieces of common information.

### Advantageous Effects of Invention

According to the present invention, an attack detection rule can be generated based on information that is common among a plurality of pieces of attack log data.

### BRIEF DESCRIPTION OF DRAWINGS

FIG. 1 is a configuration diagram of a rule generation system 200 in Embodiment 1.

FIG. 2 is a configuration diagram of a rule generation apparatus 100 in Embodiment 1.

FIG. 3 is a flowchart of a rule generation method in Embodiment 1.

FIG. 4 is a diagram illustrating an attack log file 300 in Embodiment 1.

FIG. 5 is a flowchart of a classification process (S120) in Embodiment 1.

FIG. 6 is a diagram illustrating a second element list 310 in Embodiment 1.

FIG. 7 is a flowchart of an integration process (S130) in Embodiment 1.

FIG. 8 is a diagram illustrating an alternative value list 320 in Embodiment 1.

FIG. 9 is a diagram illustrating an integrated file 330 in Embodiment 1.

FIG. 10 is a flowchart of an extraction process (S140) in Embodiment 1.

FIG. 11 is a flowchart of step S144 in Embodiment 1.

FIG. 12 is a diagram illustrating a common file 340 in Embodiment 1.

FIG. 13 is a flowchart of a generation process (S150) in Embodiment 1.

FIG. 14 is a flowchart of step S151 in Embodiment 1.

FIG. 15 is a diagram illustrating a tentative detection rule file 350 in Embodiment 1.

FIG. 16 is a diagram illustrating an analysis result file 360 in Embodiment 1.

FIG. 17 is a configuration diagram of an attack execution environment 210 in Embodiment 1.

FIG. 18 is a diagram illustrating configuration information of user terminals 211 in Embodiment 1.

FIG. 19 is a diagram illustrating an attacking means in Embodiment 1.

FIG. 20 is a flowchart of a rule generation method in Embodiment 2.

FIG. 21 is a flowchart of a generation process (S250) in Embodiment 2.

FIG. 22 is a flowchart of step S251 in Embodiment 2.

FIG. 23 is a diagram illustrating a common file 340 in Embodiment 2.

FIG. 24 is a diagram illustrating a tentative detection rule file 350 in Embodiment 2.

FIG. 25 is a flowchart of a rule generation method in Embodiment 3.

FIG. 26 is a flowchart of an extraction process (S340) in Embodiment 3.

FIG. 27 is a flowchart of step S344 in Embodiment 3.

FIG. 28 is a flowchart of a generation process (S350) in Embodiment 3.

FIG. 29 is a flowchart of step S351 in Embodiment 3.

FIG. 30 is a diagram illustrating a definition file 370 in Embodiment 4.

FIG. 31 is a flowchart of a rule generation method in Embodiment 4.

FIG. 32 is a flowchart of an integration process (S430) in Embodiment 4.

FIG. 33 is a flowchart of an extraction process (S440) in Embodiment 4.

FIG. 34 is a flowchart of step S444 in Embodiment 4.

FIG. 35 is a flowchart of a generation process (S450) in Embodiment 4.

FIG. 36 is a flowchart of step S151 in Embodiment 4.

FIG. 37 is a configuration diagram of a rule generation apparatus 100 in Embodiment 5.

FIG. 38 is a configuration diagram of an attack execution environment 210 in Embodiment 5.

FIG. 39 is a flowchart of an acquisition process (S500) in Embodiment 5.

FIG. 40 is a hardware configuration diagram of the rule generation apparatus 100 in embodiments.

### DESCRIPTION OF EMBODIMENTS

In embodiments and drawings, the same elements and equivalent elements are denoted by the same reference sign. A description of an element denoted by the same sign will be appropriately omitted or simplified. Arrows in the drawings mainly indicate data flows or process flows.

### Embodiment 1

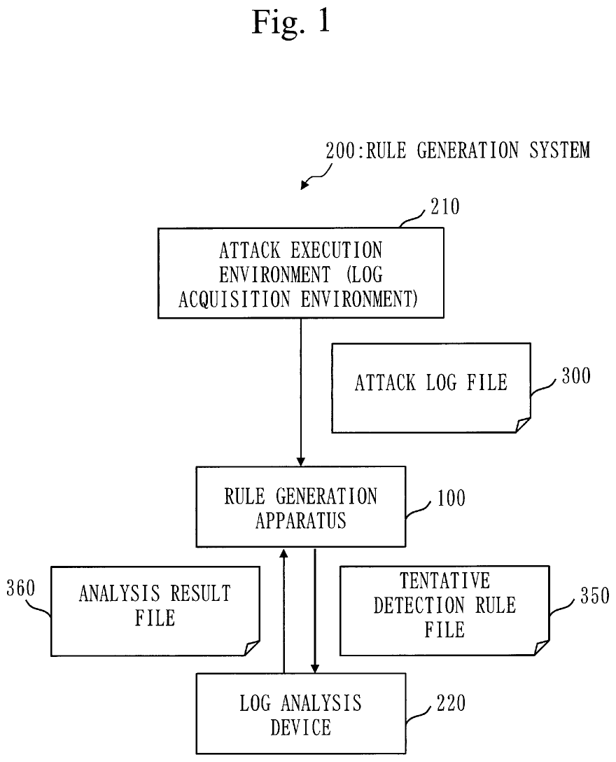

A mode of generating an attack detection rule will be described with referring to FIGS. 1 to 19.

*** Description of Configuration ***

A configuration of a rule generation system 200 will be described with referring to FIG. 1.

The rule generation system 200 is provided with a rule generation apparatus 100, an attack execution environment 210, and a log analysis device 220.

The rule generation apparatus 100 communicates with the attack execution environment 210 and the log analysis device 220.

The attack execution environment 210 is an environment to obtain an attack log file 300. The attack execution environment 210 is called log acquisition environment as well.

The rule generation apparatus 100 generates a tentative detection rule file 350 based on the attack log file 300 obtained by the attack execution environment 210.

The log analysis device 220 is a device to analyze the tentative detection rule file 350.

The rule generation apparatus 100 generates an attack detection rule based on an analysis result file 360 obtained by the log analysis device 220.

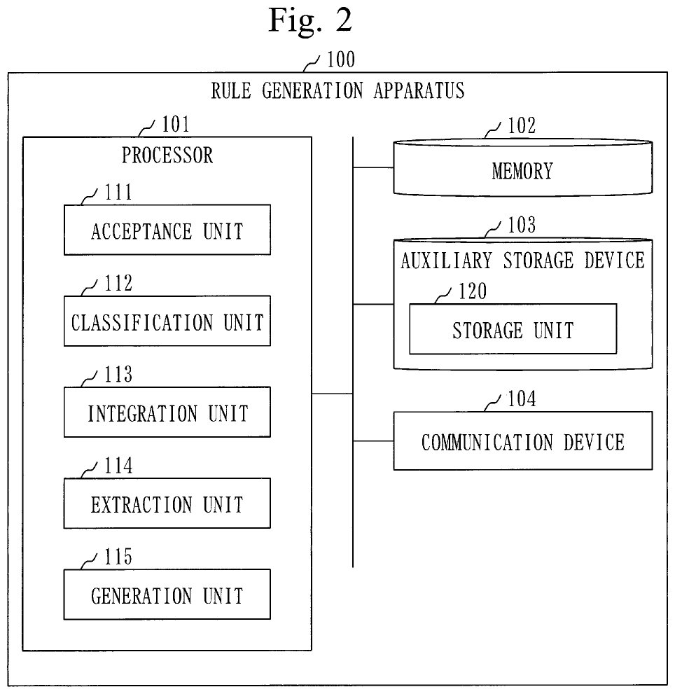

A configuration of the rule generation apparatus 100 will be described with referring to FIG. 2.

The rule generation apparatus 100 is a computer provided with hardware devices such as a processor 101, a memory 102, an auxiliary storage device 103, and a communication device 104. These hardware devices are connected to each other via signal lines.

The processor 101 is an Integrated Circuit (IC) which performs computation processing and controls the other hardware devices. For example, the processor 101 is a Central Processing Unit (CPU), a Digital Signal Processor (DSP), or a Graphics Processing Unit (GPU).

The memory 102 is a volatile storage device. The memory 102 is also called a main storage device or main memory. For example, the memory 102 is a Random Access Memory (RAM). Data stored in the memory 102 is saved in the auxiliary storage device 103 as necessary.

The auxiliary storage device 103 is a nonvolatile storage device. For example, the auxiliary storage device 103 is a Read Only Memory (ROM), a Hard Disk Drive (HDD), or a flash memory. Data stored in the auxiliary storage device 103 is loaded to the memory 102 as necessary.

The communication device 104 is a receiver/transmitter. For example, the communication device 104 is a communication chip or a Network Interface Card (NIC).

The rule generation apparatus 100 is provided with elements such as an acceptance unit 111, a classification unit 112, an integration unit 113, an extraction unit 114, and a generation unit 115. These elements are implemented by software.

In the auxiliary storage device 103, a rule generation program is stored which causes the computer to serve as the acceptance unit 111, the classification unit 112, the integration unit 113, the extraction unit 114, and the generation unit 115. The rule generation program is loaded to the memory 102 and executed by the processor 101.

Furthermore, in the auxiliary storage device 103, an Operating System (OS) is stored. At least part of the OS is loaded to the memory 102 and executed by the processor 101.

Namely, the processor 101 executes the rule generation program while executing the OS.

Data obtained by executing the rule generation program is stored in a storage device such as the memory 102, the auxiliary storage device 103, a register in the processor 101, and a cache memory in the processor 101.

The auxiliary storage device 103 serves as a storage unit 120. Note that another storage may serve as the storage unit 120 in place of the auxiliary storage device 103 or along with the auxiliary storage device 103.

The rule generation apparatus 100 may be provided with a plurality of processors that substitute for the processor 101. The plurality of processors share the role of the processor 101.

The rule generation program can be computer readably recorded (stored) in a nonvolatile recording medium such as an optical disk and a flash memory.

*** Description of Operation ***

Operations of the rule generation apparatus 100 are equivalent to a rule generation method. A procedure of the rule generation method is equivalent to a procedure of the rule generation program.

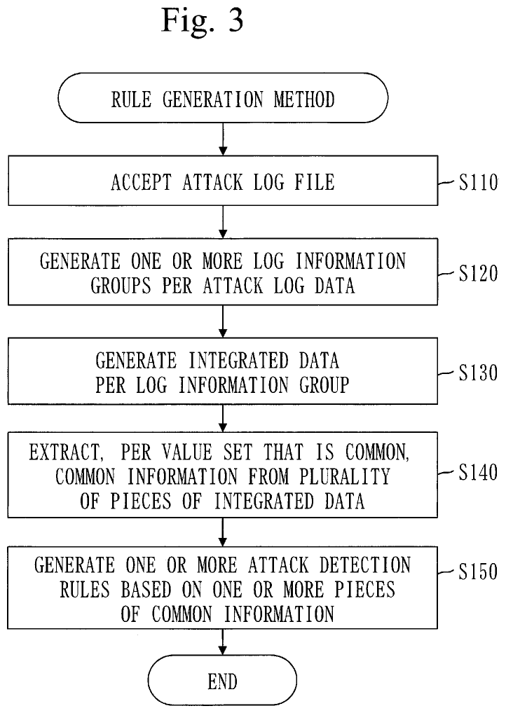

The rule generation method will be described with referring to FIG. 3.

In step S110, the acceptance unit 111 accepts the attack log file 300 from the attack execution environment 210.

Then, the acceptance unit 111 stores the attack log file 300 to the storage unit 120.

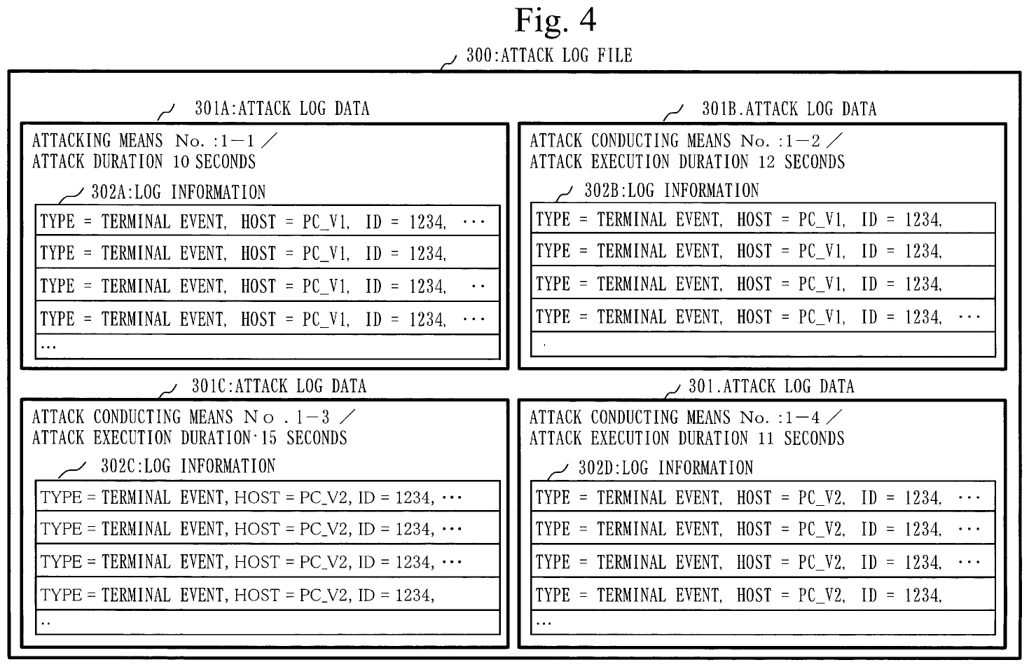

The attack log file 300 will be described with referring to FIG. 4.

The attack log file 300 includes a plurality of pieces of attack log data. The plurality of pieces of attack log data are obtained by conducting a plurality of attacking activities. The attack log file 300 of FIG. 4 includes four pieces of attack log data.

Where the attack log data is not specified, each piece of attack log data will be referred to as attack log data 301.

The attack log data 301 includes attacking means No., attack duration, and one or more pieces of log information.

Attacking means No. is a number that identifies an attacking means.

Attack duration is a length of time during which an attack is carried out.

Where log information is not specified, each piece of log information will be referred to as log information 302.

The log information 302 has a value of each of one or more elements. The value of each element will be called an element value.

The log information 302 of FIG. 4 has element values of elements such as log type, acquisition source host, and Identifier (ID).

The log type is a type of the log information 302. In FIG. 4, “TYPE” signifies log type. An example of the log type is terminal event.

The acquisition source host is a host that has acquired a log. In FIG. 4, “HOST” signifies acquisition source host. An example of the acquisition source host is host PC_V1.

ID is an identifier that identifies a terminal event.

Back to FIG. 3, the description continues from step S120.

In step S120, the classification unit 112 classifies, per attack log data 301 of the plurality of pieces of attack log data 301, one or more pieces of log information 302 included in the attack log data 301, by value set consisting of a value of a first element and a value of a second element.

Doing this, the classification unit 112 generates one or more log information groups per attack log data 301.

A log information group consists of one or more pieces of log information 302 having first elements of the same value and second elements of the same value.

A classification process (S120) will be described later in detail.

In step S130, the integration unit 113 integrates, per log information group of the plurality of pieces of attack log data 301, one or more pieces of log information 302 included in the log information group.

Doing this, the integration unit 113 generates integrated data per log information group.

The integrated data indicates features of one or more pieces of log information 302 included in the log information group.

An integration process (S130) will be described later in detail.

In step S140, the extraction unit 114 extracts, per value set, in one or more value sets, that is common among the plurality of pieces of attack log data 301, common information from a plurality of pieces of integrated data corresponding to the plurality of pieces of attack log data 301.

The common information is information that is common among the plurality of pieces of integrated data corresponding to the plurality of pieces of attack log data 301.

An extraction process (S140) will be described later in detail.

In step S150, the generation unit 115 generates one or more attack detection rules based on one or more pieces of common information extracted in step S140.

The attack detection rule indicates a feature of the attacking activity.

A generation process (S150) will be described later in detail.

If common information is not extracted in step S140, a feature that is common among the plurality of pieces of attack log data 301 related to the same attacking activity cannot be extracted from the accepted attack log file 300. Hence, the processing of the rule generation method ends.

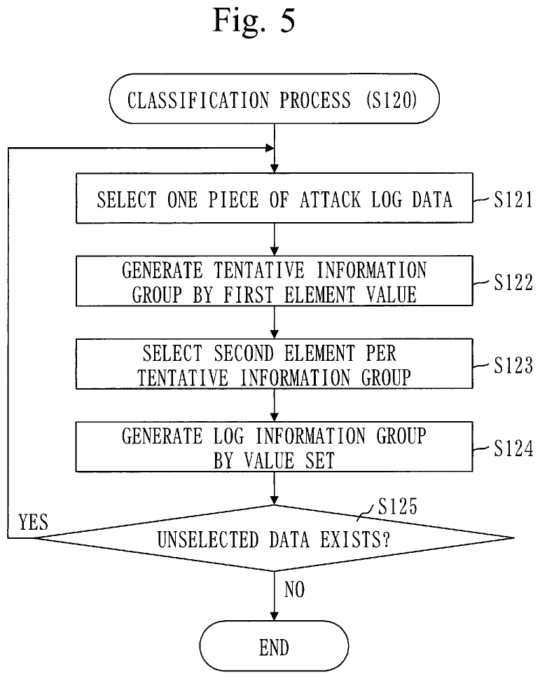

The procedure of the classification process (S120) will be described with referring to FIG. 5.

In step S121, the classification unit 112 selects one piece of unselected attack log data 301 from the attack log file 300.

For example, the classification unit 112 selects attack log data 301A from the attack log file 300 of FIG. 4.

Step S122 to step S125 are executed for the sake of the attack log data 301 selected in step S121.

In step S122, the classification unit 112 classifies one or more pieces of log information 302 included in the attack log data 301, by first element value. The first element value is a value of the first element.

Doing this, the classification unit 112 generates one or more tentative information groups by first element value.

A tentative information group consists of one or more pieces of log information 302 having the same first element value.

In the attack log file 300 of FIG. 4, the first element of the attack log data 301A is log type (TYPE).

The attack log data 301A includes 100 pieces of log information 302A.

In every log information 302A, the log type is terminal event.

In this case, the classification unit 112 generates one tentative information group. This tentative information group consists of 100 pieces of log information 302 whose log type is terminal event.

Back to FIG. 5, the description continues from step S123.

In step S123, the classification unit 112 selects a second element corresponding to the first element value, per tentative information group.

Specifically, the classification unit 112 acquires a second element corresponding to the first element value from a second element list 310.

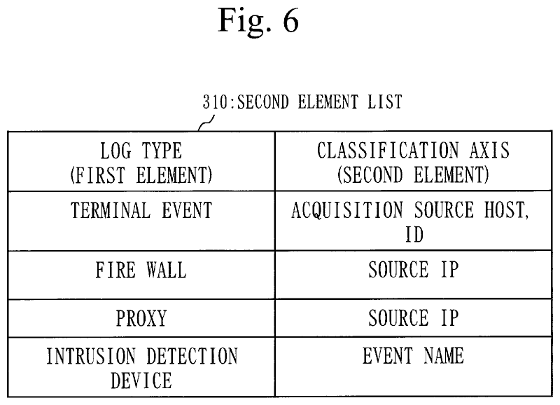

The second element list 310 will be described with referring to FIG. 6.

The second element list 310 indicates second elements corresponding to the first element values.

The log type is first element. The value of the log type is first element value. The classification axis is second element.

When the first element value is terminal event, the classification unit 112 acquires a classification axis corresponding to the terminal event from the second element list 310. The acquired classification axis includes acquisition source host and ID. The acquisition source host and the ID are each a second element.

Back to FIG. 5, the description continues from step S124.

In step S124, the classification unit 112 classifies one or more pieces of log information 302 included in the attack log data 301, by value set consisting of the first element value and a second element value. The second element value is a value of the second element.

Doing this, the classification unit 112 generates one or more log information groups, by value set consisting of the first element value and the second element value.

A log information group consists of one or more pieces of log information 302 having the same first element values and the same second element values.

In the attack log file 300 of FIG. 4, the first element of the attack log data 301A is log type (TYPE).

The attack log data 301A includes 100 pieces of log information 302A.

In every log information 302A, the log type is terminal event.

In the second element list 310 of FIG. 6, a second element corresponding to the terminal event includes acquisition source host and ID.

In every log information 302A of FIG. 4, the acquisition source host (HOST) is PC_V1, and the ID is 1234.

In this case, the classification unit 112 generates one log information group. This log information group consists of 100 pieces of log information 302 in each of which the log type is terminal event, the acquisition source host is PC_V1, and the ID is 1234.

Back to FIG. 5, the description continues from step S125.

In step S125, the classification unit 112 checks whether unselected attack log data exists. In step S125, unselected attack log data 301 is called unselected data.

If unselected data exists, the processing advances to step S121.

If unselected data does not exist, the processing ends.

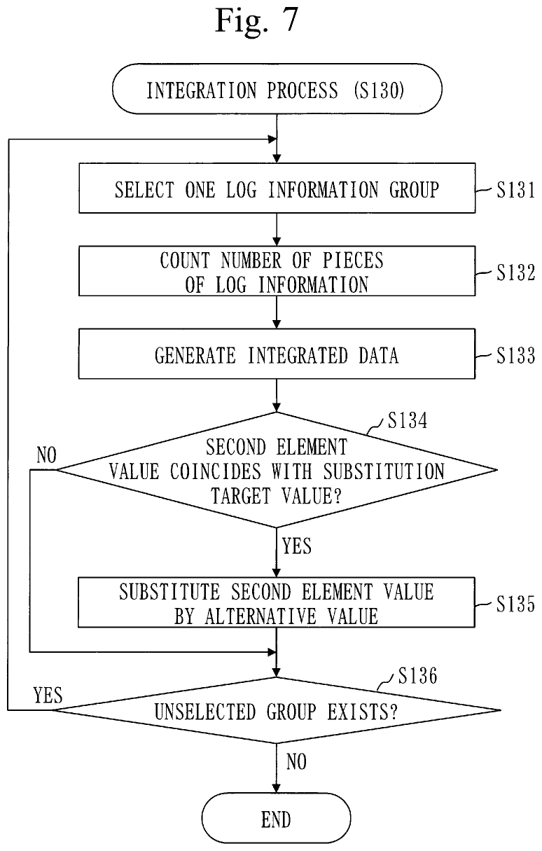

The integration process (S130) will be described with referring to FIG. 7.

In step S131, the integration unit 113 selects one unselected log information group from among log information groups in each of the plurality of pieces of attack log data 301.

Step S132 to step S138 are executed for the sake of the log information group selected in step S131.

In step S132, the integration unit 113 counts a number of pieces of the log information 302 included in the log information group.

In step S133, the integration unit 113 integrates one or more pieces of log information 302 included in the log information group.

Doing this, the integration unit 113 generates integrated data.

The integration unit 113 generates the integrated data as follows.

The integration unit 113 acquires a data identifier of attack log data 301 corresponding to the log information group. Specifically, the integration unit 113 extracts attacking means No. from the attack log data 301.

The integration unit 113 extracts a first element value and a second element value from one piece of log information 302 of the log information group. The extracted first element value is common among all pieces of log information 302 included in the log information group. The extracted second element value is common among the all pieces of log information 302 included in the log information group.

Then, the integration unit 113 generates data including a data identifier, a first element value, a second element value, and the number of pieces of the log information 302. The data to be generated forms the integrated data.

In step S134, the integration unit 113 checks whether the second element value coincides with a substitution target value.

A substitution target value is a value that is a target of substitution by an alternative value.

An alternative value is a value that is an alternative of a substitution target value.

The integration unit 113 performs checking as follows.

An alternative value list 320 is stored in the storage unit 120 in advance. The alternative value list 320 illustrates correspondence between one or more alternate values and one or more substitution target values.

The integration unit 113 checks whether a substitution target value coinciding with the second element value is included in the alternative value list 320.

If the second element value coincides with the substitution target value, the processing advances to step S135.

If the second element value does not coincide with the substitution target value, the processing advances to step S136.

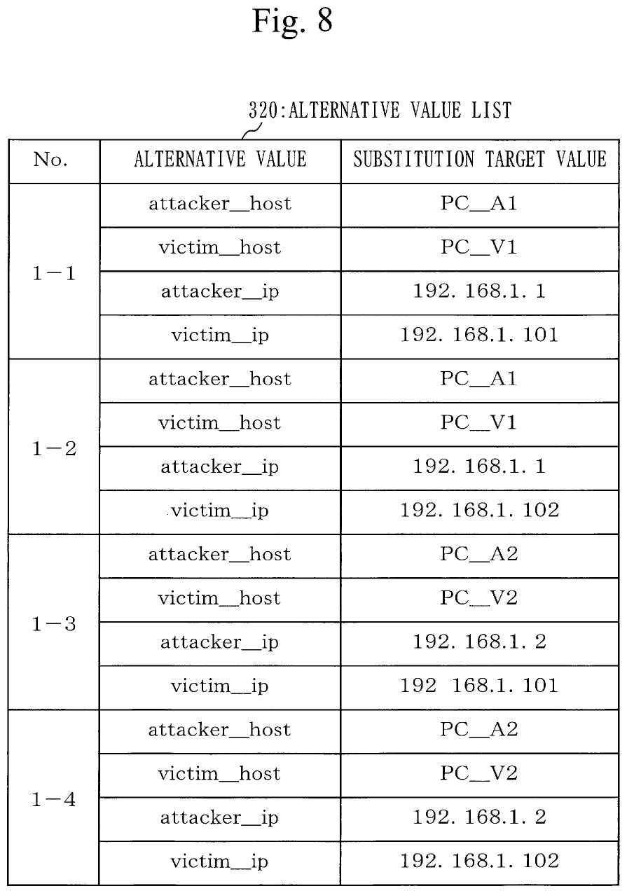

The alternative value list 320 will be described with referring to FIG. 8.

The alternative value list 320 illustrates correspondence among attacking means No., one or more alternative values, and one or more substitution target values.

In the attack log file 300 of FIG. 4, the attacking means No. of the attack log data 301A is “1-1”. The attack log data 301A includes 100 pieces of log information 302A. The log information group of the attack log data 301A consists of 100 pieces of log information 302A. In the attack log data 301A, the first element value is “terminal event”.

In the second element list 310 of FIG. 6, the second element corresponding to “terminal event” is each of acquisition source host (HOST) and ID.

In the attack log data 301A of FIG. 4, the second element value is each of “PC_V1” and “1234”.

The integration unit 113 selects four substitution target values corresponding to the attacking means No. “1-1” from the alternative value list 320 of FIG. 8. The selected four substitution target values are “PC_A1”, “PC_V1”, “192.168.1.1”, and “192.168.1.101”.

Then, the integration unit 113 checks whether a substitution target value coinciding with the second element value is included in the four selected substitution target values.

The second element value “1234” coincides with none of the four substitution target values. The second element value “PC_V1” coincides with a substitution target value “PC_V1”.

In this case, the integration unit 113 decides that the second element value coincides with the substitution target value.

Back to FIG. 7, the description continues from step S135.

In step S135, the integration unit 113 substitutes the second element values in the integrated data by an alternative value.

The integration unit 113 performs substitution as follows.

First, the integration unit 113 extracts an alternative value corresponding to a substitution target value coinciding with the second element value from the alternative value list 320.

Then, the integration unit 113 substitutes the second element value in the integrated data by the alternative value.

In step S136, the integration unit 113 checks whether an unselected log information group exists. In step S136, an unselected log information group is called unselected group.

If an unselected group exists, the processing proceeds to step S131.

If an unselected group does not exist, the processing ends.

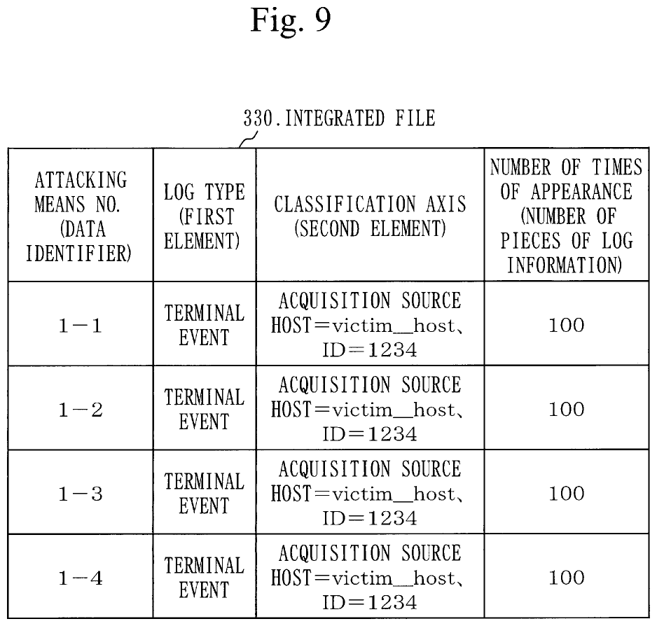

An integrated file 330 will be described with referring to FIG. 9.

The integrated file 330 includes integrated data of the log information groups. The integration unit 113 generates the integrated file 330 using the integrated data of the log information groups and stores the integrated file 330 to the storage unit 120.

Each piece of integrated data includes attacking means No., log type, classification axis, and a number of times of appearance.

Attacking means No. is equivalent to a data identifier of the attack log data 301 corresponding to the log information group.

Log type is equivalent to the first element, and a value of the log type is equivalent to the first element value.

Classification axis is equivalent to the second element, and a value of the classification axis is equivalent to a second element value.

Number of times of appearance is equivalent to a number of pieces of log information 302 included in the log information group.

In integrated data whose attacking means No. is “1-1”, an initial value of an acquisition source host is “PC_V1”.

In the alternative value list 320 of FIG. 8, “PC_V1” is a substitution target value, and an alternative value corresponding to “PC_V1” is “victim_host”.

For this reason, in integrated data (see FIG. 9) whose attacking means No. is “1-1”, a value of the acquisition source host is substituted by “victim_host”.

As for integrated data whose attacking means No. is “1-2”, “1-3”, or “1-4”, a value of an acquisition source host is substituted by “victim_host”, as with the integrated data whose attacking means No. is “1-1”.

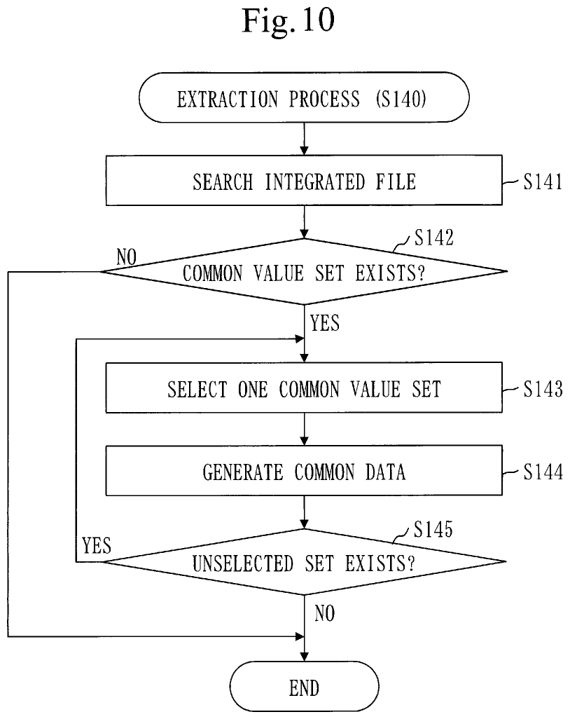

The extraction process (S140) will be described with referring to FIG. 10.

In step S141, the extraction unit 114 searches the integrated file 330 to find a value set that is common among the plurality of pieces of attack log data 301. Note that a value set is a set of a first element value and a second element value.

In processing of step S142 and beyond, a value set that is common among the plurality of pieces of attack log data 301 will be called common value set.

In step S142, the extraction unit 114 checks whether a common value set exists, based on a search result.

If a common value set exists, the processing proceeds to step S143.

If a common value set does not exist, the processing ends.

In the integrated file 330 of FIG. 9, each of the four pieces of integrated data has a common first element value “terminal event” and a common second element value “victim_host” and “1234”.

Hence, a set of the first element value “terminal event” and the second element value “victim_host” and “1234” is a common value set.

Back to FIG. 10, the description continues from step S143.

In step S143, the extraction unit 114 selects one unselected common value set.

Step S144 is executed for the sake of the common value set selected in step S143.

In step S144, the extraction unit 114 generates common data based on a plurality of pieces of integrated data corresponding to the common value set.

Each of the plurality of integrated data includes a common value set.

The common data includes common information.

Step S144 will be described later in detail.

In step S145, the extraction unit 114 checks whether an unselected common value set exists.

In step S145, an unselected common value set is called unselected set.

If an unselected set exists, the processing proceeds to step S143.

If an unselected set does not exist, the processing ends.

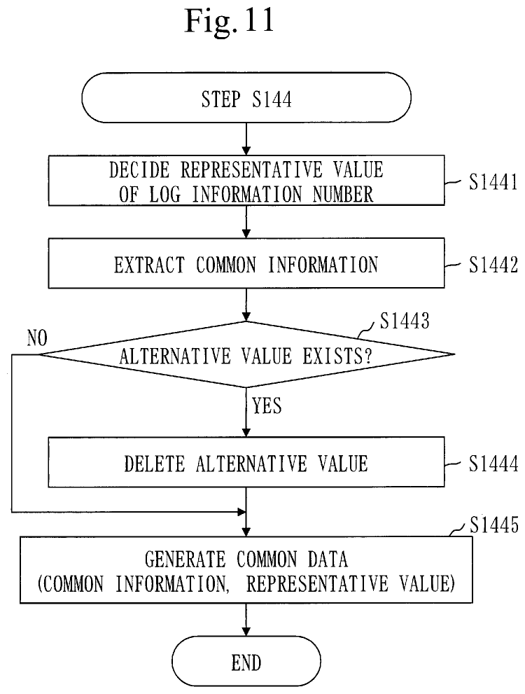

Step S144 will be described with referring to FIG. 11.

In step S1441, the extraction unit 114 decides a representative value of a log information number based on a plurality of log information numbers included in the plurality of pieces of integrated data.

A log information number is a number of pieces of the log information 302.

Specifically, the extraction unit 114 selects a minimum log information number from the plurality of log information numbers. The log information number to be selected is the representative value.

Note that the extraction unit 114 may decide on a value other than the minimum log information number as the representative value. For example, the extraction unit 114 may decide on a maximum log information number or an average of the log information numbers as the representative value.

In the integrated file 330 of FIG. 9, in any of the four pieces of integrated data, the log information number is 100.

In this case, the extraction unit 114 decides on 100 as the representative value of the log information number.

Back to FIG. 11, the description continues from step S1442.

In step S1442, the extraction unit 114 extracts the common information from the plurality of pieces of integrated data.

Specifically, the extraction unit 114 extracts the first element value and the second element value.

In the case of the integrated file 330 of FIG. 9, the extraction unit 114 extracts log type “terminal event” and classification axis “acquisition source host=victim_host” and “ID=1234”.

Back to FIG. 11, the description continues from step S1443.

In step S1443, the extraction unit 114 checks whether an alternative value is included in the common information.

If an alternative value is included in the common information, the processing proceeds to step S1444.

If an alternative value is not included in the common information, the processing proceeds to step S1445.

In step S1444, the extraction unit 114 deletes the alternative value from the common information.

In the integrated file 330 of FIG. 9, the common information consists of “terminal event”, “acquisition source host=victim_host”, and “ID=1234”. As illustrated in FIG. 8, “victim_host” is an alternative value.

Therefore, the extraction unit 114 deletes “acquisition source host=victim_host” from the common information.

Note that the extraction unit 114 may change the alternative value in the common information to “an arbitrary value that an element including an alternative value can take”, in place of deleting the alternative value from the common information.

For example, in the integrated file 330 of FIG. 9, the extraction unit 114 changes alternative value “victim_host” to arbitrary value “ANY”. That is, the extraction unit 114 changes “acquisition source host=victim_host” to “acquisition source host=ANY”. An arbitrary value “ANY” represents an arbitrary value in a range of values that the element name can take. In this case, this common information includes information “terminal event” and “ID=1234”. This common information signifies that a number of times of appearance of the log information 302 having a certain fixed acquisition host name is 100.

Back to FIG. 11, step S1445 will be described.

In step S1445, the extraction unit 114 generates data including the common information and the representative value of the log information number. The generated data is the common data.

Then, the extraction unit 114 stores the common data to the storage unit 120.

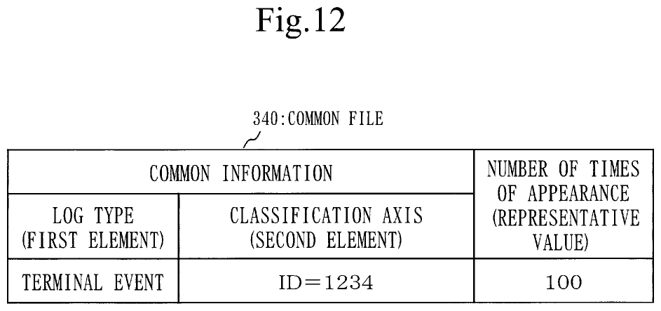

A common file 340 will be described with referring to FIG. 12.

The common file 340 includes one or more pieces of common data. The extraction unit 114 generates the common file 340 and stores the common file 340 to the storage unit 120.

The common file 340 of FIG. 12 includes one piece of common data.

The common data includes common information and the number of times of appearance.

The common information includes the value of the log type and the value of the classification axis. The value of the log type is equivalent to the first element value. The value of the classification axis is equivalent to the second element value.

The number of times of appearance is equivalent to the representative value of the log information number.

In a column of the classification axis of the common information, “acquisition source host=victim_host” including an alternate value “victim_host” has been deleted.

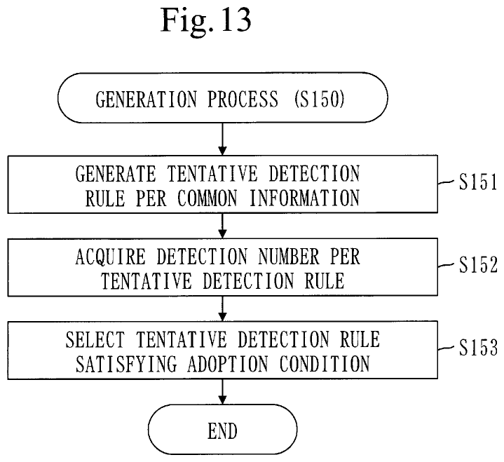

A generation process (S150) will be described with referring to FIG. 13.

In step S151, the generation unit 115 generates a tentative detection rule per common information.

The tentative detection rule is a candidate of the attack detection rule.

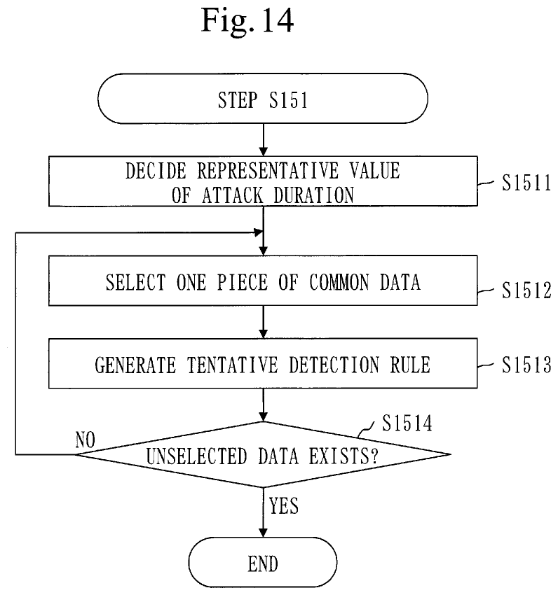

A procedure of step S151 will be described with referring to FIG. 14.

In step S1511, the generation unit 115 decides a representative value of a plurality of attack durations corresponding to the plurality of pieces of attack log data 301.

Specifically, the generation unit 115 acquires a plurality of attack durations from the plurality of pieces of attack log data 301 and selects the longest attack duration from among the plurality of attack durations. The selected attack duration is the representative value.

The generation unit 115 may decide on an attack duration other than the longest attack duration as the representative value. For example, the generation unit 115 may decide on the shortest attack duration or an average attack duration as the representative value.

In the attack log file 300 of FIG. 4, the longest attack duration is 15 seconds.

In this case, the generation unit 115 decides on 15 seconds as the representative value of the attack duration.

Back to FIG. 14, the description continues from step S1512.

In step S1512, the generation unit 115 selects one piece of unselected common data.

Step S1513 is executed for the sake of the common data selected in step S1512.

In step S1513, the generation unit 115 generates a tentative detection rule based on the common data and the representative value of the attack duration.

The tentative detection rule includes the common information, the representative value of the log information number, and the representative value of the attack duration.

In step S1514, the generation unit 115 checks whether unselected common data exists. In step S1514, unselected common data is called unselected data.

If unselected data exists, the processing proceeds to step S1512.

If unselected data does not exist, the processing ends.

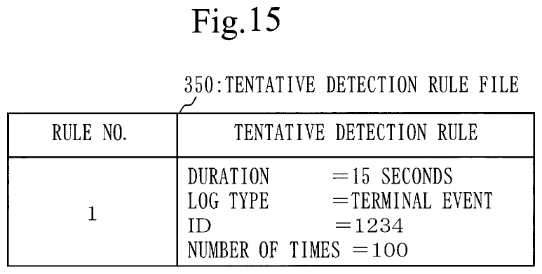

The tentative detection rule file 350 will be described with referring to FIG. 15.

The tentative detection rule file 350 includes one or more tentative detection rules. The generation unit 115 generates the tentative detection rule file 350 and stores the tentative detection rule file 350 to the storage unit 120.

The tentative detection rule file 350 of FIG. 15 includes one tentative detection rule.

The common file 340 of FIG. 12 includes one piece of common data. In this common data, the common information consists of “terminal event” and “1234”, and the representative value of the log information number is “100”.

In the attack log file 300 of FIG. 4, the representative value of the attack duration is “15 seconds”.

In the tentative detection rule file 350 of FIG. 15, the tentative detection rule includes these values. This tentative detection rule indicates a condition “log information whose log type is terminal event and whose ID is 1234 has appeared 100 times within 15 seconds”.

Back to FIG. 13, the description continues from step S152.

In step S152, the generation unit 115 acquires a detection number per tentative detection rule.

A detection number is a number of times an incident that meets the tentative detection rule is detected.

Specifically, the generation unit 115 transmits the tentative detection rule file 350 to the log analysis device 220 and receives the analysis result file 360 from the log analysis device 220.

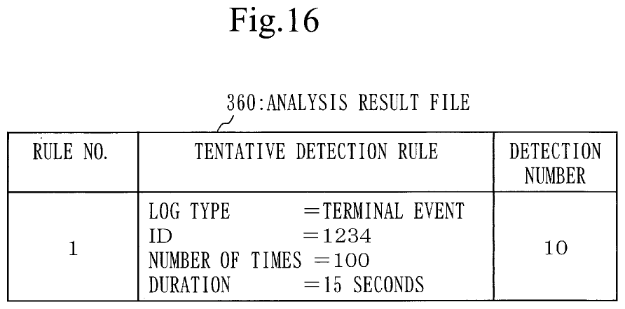

The analysis result file 360 will be described with referring to FIG. 16.

The analysis result file 360 indicates the detection number of each tentative detection rule.

The detection number is a number of times an incident that meets a tentative detection rule appears within a predetermined period of time. The detection number is equivalent to a number of times log information on an incident that meets the tentative detection rule appears within a predetermined period of time.

Back to FIG. 13, step S153 will be described.

In step S153, the generation unit 115 selects a tentative detection rule that corresponds to a detection number satisfying an adoption condition. The selected tentative detection rule is adopted as the attack detection rule.

The adoption condition is a condition about the detection number and is determined in advance.

For example, the adoption condition indicates a threshold value. The generation unit 115 selects, as the attack detection rule, a tentative detection rule whose detection number is smaller than the threshold value.

The analysis result file 360 of FIG. 16 includes one tentative detection rule. The detection number of this tentative detection rule is 10. In a case where the threshold value indicated by the adoption condition is 15, the detection number of this tentative detection rule is smaller than the threshold value. Hence, the generation unit 115 selects this tentative detection rule as the attack detection rule.

*** Additional Description on Configuration ***

The attack execution environment 210 will now be described.

The attack execution environment 210 executes a plurality of attacking means and collects the log information 302.

The attack execution environment 210 is configured of one or more constituent elements that can execute an attack according to each attacking means.

The attack execution environment 210 has a function of collecting the log information 302 occurring in each constituent element at the time each attacking means is executed.

The attack execution environment 210 has a function of measuring an attack duration. The attack duration is an elapsed time point having elapsed since execution of an attacking means is started until execution of the attacking means is ended.

The attacking means is a specific means that practices an attacking activity. That is, the attacking means is information such as an attacker, an attacking destination, and attack details, which are concretized for practicing the attacking activity.

For example, as an attacking means of an attacking activity “brute force attack using log-in passwords”, a means to “try log-in from a host A to a host B 100 times with different passwords” is raised.

Any attacking means suffices as far as it has an element that concretizes at least some practicing means for the attacking activity. For example, the attacking means may be a means to “conduct a brute force attack with log-in passwords from a host A”. Also, the attacking means may be a means to “try log-in from a host A to a host B 100 times utilizing a tool C with different passwords”.

The attack execution environment 210 can be configured of a simulated information system that simulates a general information system partly or entirely.

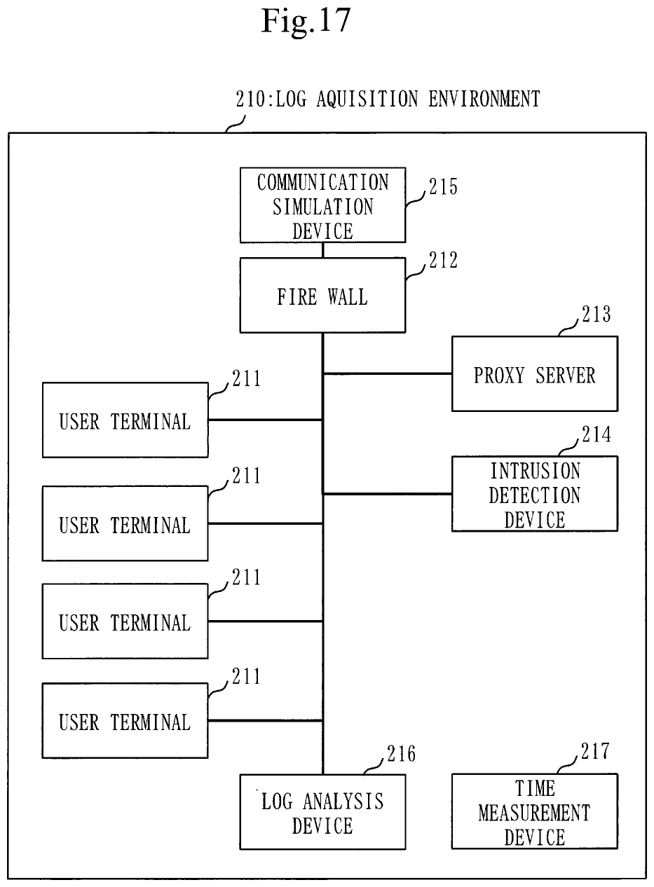

A configuration of the attack execution environment 210 will be described with referring to FIG. 17.

The attack execution environment 210 is provided with one or more user terminals 211.

Furthermore, the attack execution environment 210 is provided with a fire wall 212, a proxy server 213, an intrusion detection device 214, a communication simulation device 215, a log analysis device 216, and a time measurement device 217.

The user terminals 211, the fire wall 212, the proxy server 213, the intrusion detection device 214, and the log analysis device 216 are connected to each other.

The communication simulation device 215 is connected to the other constituent elements via the fire wall 212.

The communication simulation device 215 simulates communication between the attack execution environment 210 and the outside.

Specifically, the communication simulation device 215 returns a quasi-response to a constituent element that tries communication with the outside of the attack execution environment 210. The communication simulation device 215 also generates quasi-communication from the outside to the attack execution environment 210.

The communication simulation device 215 can be implemented by an existing technique.

The log analysis device 216 collects a plurality of types of log information 302 generated by the information system and analyzes the plurality of types of log information 302. A specific example of an analyzing technique is Security Information and Event Management (SIEM).

The time measurement device 217 measures an attacking time point.

The elements constituting the simulated information system can record, as the log information 302, operations caused by execution of the attacking means as much as possible.

For example, each user terminal 211 records log information 302 of a terminal event such as a log-on trial and an access to data. The intrusion detection device 214 also records, as the log information 302, alert information occurring by execution of the attacking means.

The configuration of the attack execution environment 210 is not necessarily the configuration illustrated in FIG. 17. In other words, an element may be added or deleted as necessary. The attack execution environment 210 need not be provided with a communication simulation device 215, and the attack execution environment 210 may be connected to the outside. The outside means is, for example, the Internet.

The attack execution environment 210 need not be a simulated information system as far as it has a function of collecting the log information 302 and a function of measuring the attack duration. For example, an actual information system may be utilized, partly or entirely, as the attack execution environment 210. Alternatively, a virtual device that can reproduce a response and log information equivalent to a response and log information in an actual information system may be utilized as the attack execution environment 210. A combination of the actual information system and virtual device may be utilized as the attack execution environment 210.

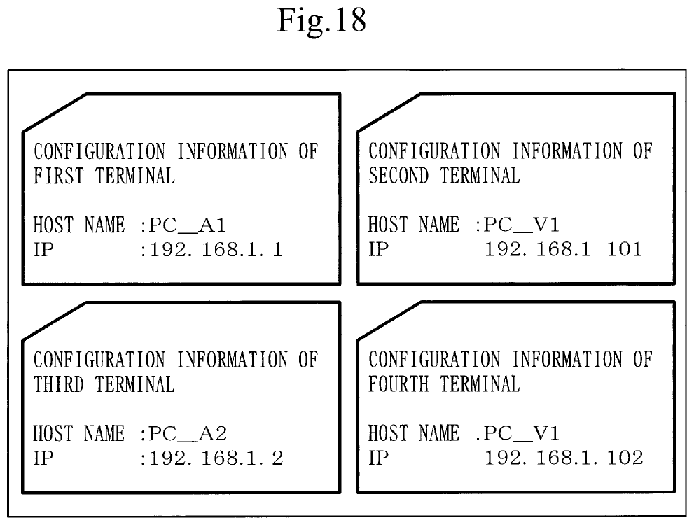

FIG. 18 illustrates configuration information of the user terminals 211, as an example of configuration information concerning the constituent elements of the attack execution environment 210.

In FIG. 18, each of the first to fourth terminals signifies a user terminal 211.

The configuration information of the user terminal 211 has a host name and an IP address. Note that IP stands for Internet Protocol.

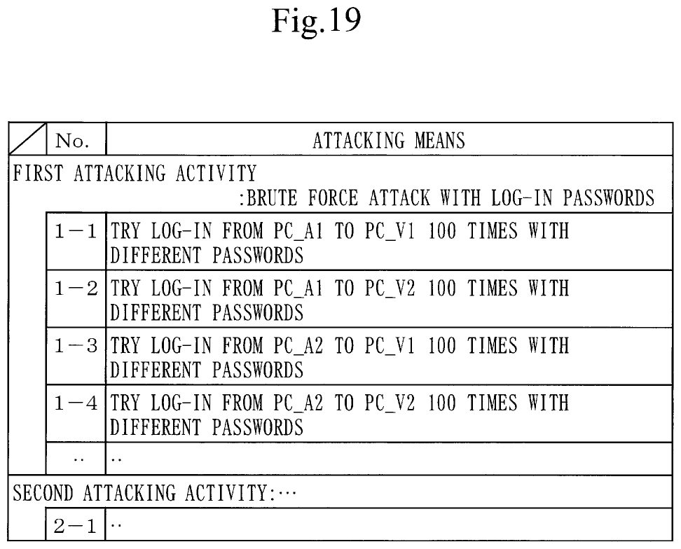

FIG. 19 illustrates an example of the attacking means.

A first attacking activity is “brutal force attack with log-in passwords”. FIG. 19 illustrates four attacking means related to the first attacking activity. Among the four attacking means, a set of an attacker and an attacking destination differs. The attack log file 300 of FIG. 4 is an example of an attack log file obtained by execution of the four attacking means illustrated in FIG. 19.

In a case of conducting an attacking activity based on the attacking means, the user may conduct the attacking activity according to the attacking means, or the attacking activity may be conducted with utilizing an attacking device. The attacking device is a device that conducts the attacking activity according to the attacking means. For example, the attacking device is provided to the attack execution environment 210.

The log analysis device 220 will now be described.

The log analysis device 220 is a device similar to the log analysis device 216 of the attack execution environment 210. That is, the log analysis device 220 collects a plurality of types of log information generated by the information system and analyzes the plurality of types of log information.

The log analysis device 220 receives the tentative detection rule file 350 from the rule generation apparatus 100 and detects occurrence of an incident that meets each tentative detection rule included in the tentative detection rule file 350. Occurrence of an incident that meets a tentative detection rule is referred to as detection by the tentative detection rule. Also, to establish a state where detection by a tentative detection rule can be performed is referred to as application of a tentative detection rule.

The log analysis device 220 records a number of times an incident that meets an applied tentative detection rule has occurred.

If the log analysis device 216 of the attack execution environment 210 has the above function, a device of the same type as the log analysis device 216 may be used as the log analysis device 220. Also, another device having the same function as the above function may be used as the log analysis device 220.

The analysis result file 360 obtained by the log analysis device 220 is a result obtained by totaling the detection numbers of the tentative detection rule which has been applied to a normal log.

The normal log is log information which occurs when an environment having one or more constituent elements making up the information system is activated by some means that is not an attacking means. For example, the normal log is log information which occurs while the user utilizes a business system of a company. The normal log is desirably acquired from an environment having the same configuration as the configuration in the attack execution environment 210, a configuration which is similar as much as possible to the configuration in the attack execution environment 210, or a configuration that can acquire log information similar to the log information in the attack execution environment 210.

The normal log is desirably log information of a case where an environment having one or more constituent elements making up an information system is used for a primary objective of the environment, or log information obtained by reproducing log information of a case where such environment is used for the primary objective of the environment. For example, assume that a given environment is a business system of a company. The primary objective of the business system is that the business system is utilized by a user in the business. For this reason, the normal log is desirably log information occurring while the user uses the business system for the sake of the business, or log information that reproduces such log information.

It is not essential that the normal log be log information of a case where an environment having one or more constituent elements making up an information system is used for a primary objective of the environment, or log information obtained by reproducing log information of a case where such environment is used for the primary objective of the environment.

*** Effect of Embodiment 1 ***

One or more tentative detection rules based on a feature that is common among the plurality of attacking means can be generated, with taking as input the attack log file 300 obtained by executing a plurality of attacking means. Then, a tentative detection rule with which a detection number based on a normal log satisfies a prescribed condition can be obtained as an attack detection rule.

Accordingly, when obtaining an attack detection rule, an operator does not need to specify, regarding an attacking activity of a detection target, where and in what manner a trace of the attacking activity different from a normal activity remains on a monitoring target. As a result, an operator with only a limited general knowledge can create an attack detection rule.

### Embodiment 2

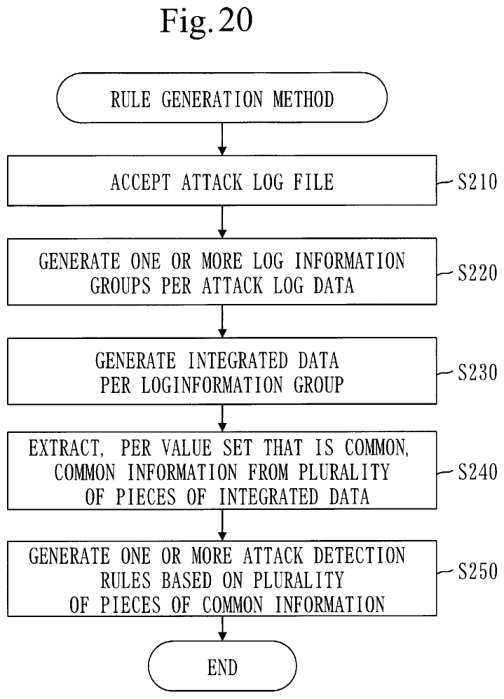

A mode of generating one tentative detection rule based on a plurality of pieces of common information will be described with referring to FIGS. 20 to 24, mainly regarding its difference from Embodiment 1.

*** Description of Configuration ***

A configuration of a rule generation system 200 is the same as the configuration in Embodiment 1 (see FIG. 1).

A configuration of a rule generation apparatus 100 is the same as the configuration in Embodiment 1 (see FIG. 2).

*** Description of Operations ***

A rule generation method will be described with referring to FIG. 20.

Step S210 to step S240 are respectively the same as step S110 to step S140 in Embodiment 1 (see FIG. 3).

In step S250, a generation unit 115 generates one or more attack detection rules based on a plurality of pieces of common information extracted in step S240.

If common information is not extracted in step S240, a feature that is common among a plurality of pieces of attack log data 301 related to the same attacking activity cannot be extracted from an accepted attack log file 300. Hence, the processing of the rule generation method ends.

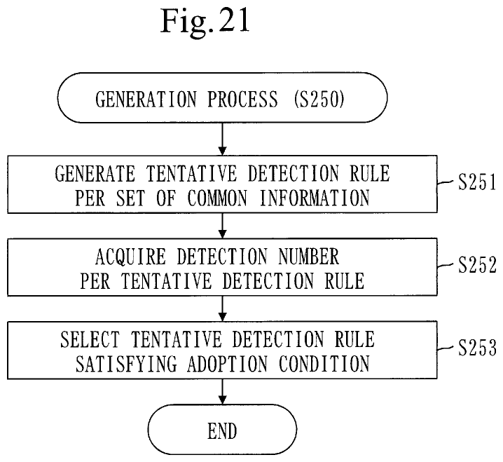

A generation process (S250) will be described with referring to FIG. 21.

In step S251, the generation unit 115 generates a tentative detection rule per set of common information.

Step S251 will be described later in detail.

Step S252 and step S253 are respectively the same as step S152 and step S153 in Embodiment 1 (see FIG. 13).

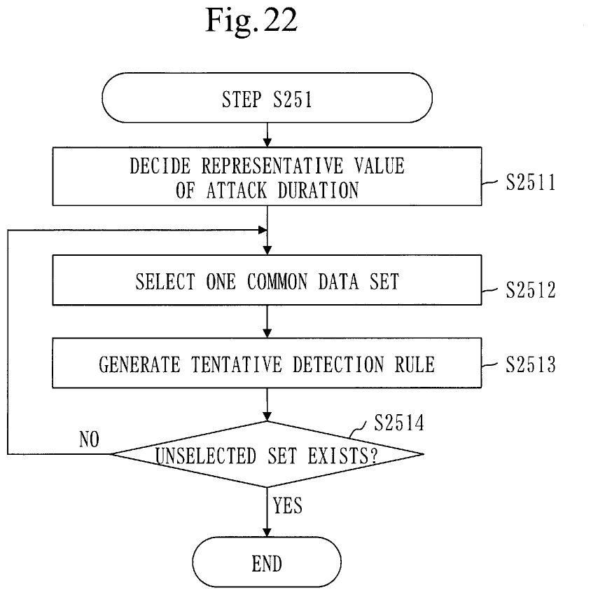

Step S251 will be described with referring to FIG. 22.

In step S2511, the generation unit 115 decides a representative value of an attack duration.

Step S2511 is the same as step S1511 in Embodiment 1 (see FIG. 14).

In step S2512, the generation unit 115 selects one unselected common data set from among one or more common data sets obtained from plurality of pieces of common data.

A common data set consists of two or more pieces of common data. For example, the common data set consists of two pieces of common data. The common data set may consist of three or more pieces of common data.

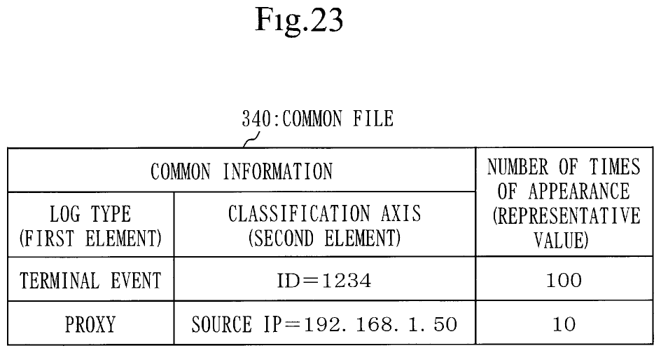

A common file 340 will be described with referring to FIG. 23.

The common file 340 includes two or more pieces of common data. The common file 340 of FIG. 23 includes two pieces of common data.

The generation unit 115 selects the two pieces of common data as the common data set.

Back to FIG. 22, the description continues from step S2513.

Step S2513 is executed for the sake of the common data set selected in step S2512.

In step S2513, the generation unit 115 generates a tentative detection rule based on the common data set and the representative value of the attack duration.

The tentative detection rule includes the representative value of the attack duration, and the common information and a representative value of log information of each common data of the common data set.

In step S2514, the generation unit 115 checks whether an unselected common data set exists. In step S2514, an unselected common data set is called an unselected set.

If an unselected set exists, the processing proceeds to step S2512.

If an unselected set does not exist, the processing ends.

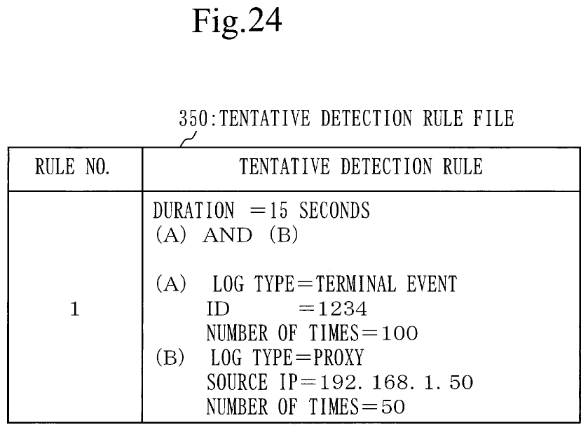

A tentative detection rule file 350 will be described with referring to FIG. 24.

The tentative detection rule file 350 of FIG. 24 includes one tentative detection rule.

This tentative detection rule indicates a condition “a condition (A) and a condition (B) were satisfied within 15 seconds”.

The condition (A) is a condition that is based on the first common data in the common file 340 of FIG. 23. Specifically, the condition (A) is a condition “log information whose log type is a terminal event and whose ID is 1234 appeared 100 times”.

The condition (B) is a condition that is based on the second common data in the common file 340 of FIG. 23. Specifically, the condition (B) is condition “log information whose log type is proxy and whose source IP is 192.168.1.50 appeared 10 times”.

*** Effect of Embodiment 2 ***

By combining a plurality of pieces of common information, a tentative detection rule on a stricter condition can be generated. Then, an attack detection rule on the stricter condition can be generated. Namely, it becomes possible to generate a tentative detection rule and attack detection rule with which a detection number based on a normal log is smaller.

### Embodiment 3

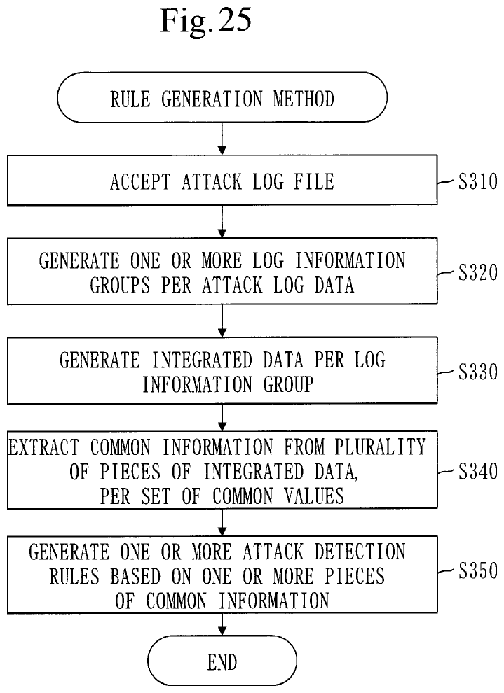

A mode of generating a tentative detection rule including a condition on an appearance cycle will be described with referring to FIGS. 25 to 29, mainly regarding its difference from Embodiment 1.

*** Description of Configuration ***

A configuration of a rule generation system 200 is the same as the configuration in Embodiment 1 (see FIG. 1).

A configuration of a rule generation apparatus 100 is the same as the configuration in Embodiment 1 (see FIG. 2).

*** Description of Operation ***

A rule generation method will be described with referring to FIG. 25.

Step S310 to step S330 are respectively the same as step S110 to step S130 in Embodiment 1 (see FIG. 3).

In step S340, an extraction unit 114 extracts common information from a plurality of pieces of integrated data, per value set that is common.

An extraction process (S340) will be described later in detail.

In step S350, a generation unit 115 generates one or more attack detection rules based on one or more pieces of common information extracted in step S340.

If common information is not detected in step S340, a feature that is common among a plurality of pieces of attack log data 301 related to the same attacking activity cannot be extracted from an accepted attack log file 300. Hence, the processing of the rule generation method ends.

A generation process (S350) will be described later in detail.

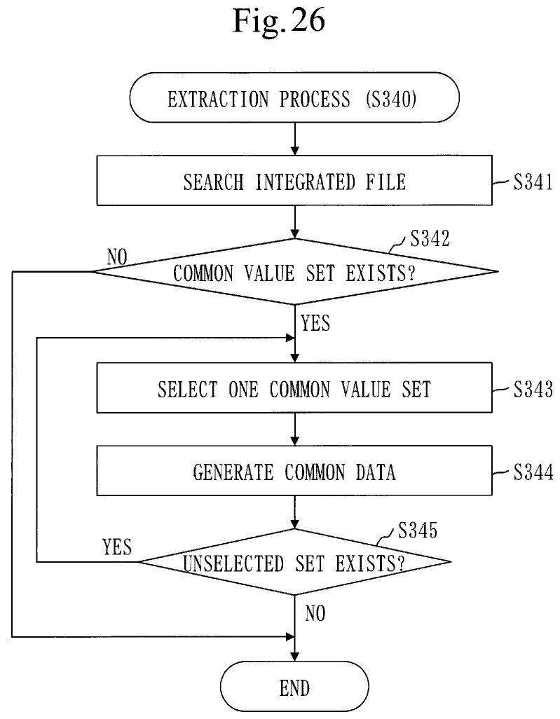

The extraction process (S340) will be described with referring to FIG. 26.

A procedure of step S341 to step S345 is the same as the procedure of step S141 to step S145 in Embodiment 1.

Note that a process of step S344 is partly different from the process of step S144 in Embodiment 1.

In step S344, the extraction unit 114 generates common data based on a plurality of pieces of integrated data corresponding to the common value sets.

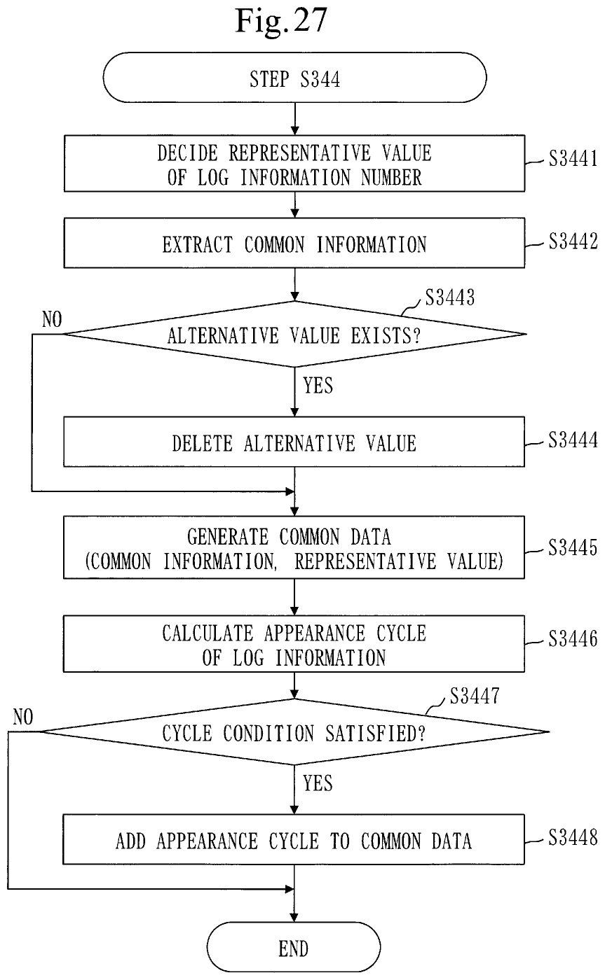

Step S344 will be described with referring to FIG. 27.

Step S3441 to step S3446 are respectively the same as step S1441 to step S1446 in Embodiment 1 (see FIG. 11).

In step S3446, the extraction unit 114 calculates an appearance cycle of log information 302.

The extraction unit 114 calculates the appearance cycle of the log information 302 as follows.

Each piece of log information 302 includes an appearance time point.

The extraction unit 114, per attack log data 301, calculates mean and variance of an appearance interval of the log information 302 based on an appearance time point of one or more pieces of log information 302. The mean and variance to be calculated are equivalent to the appearance cycle. Alternatively, the extraction unit 114 may calculate a statistic value other than the mean and variance as the appearance cycle.

In step S3447, the extraction unit 114 checks whether the appearance cycle of the log information 302 satisfies a cycle condition.

The cycle condition is a condition on the appearance cycle of the log information 302 and is decided in advance.

Specifically, the extraction unit 114 performs checking as follows.

The extraction unit 114 compares means of attack log data 301 about the appearance interval of the log information 302 and calculates a difference of the mean. The difference of the mean is a difference between a minimum mean and a maximum mean.

The extraction unit 114 compares variances of the attack log data 301 about the appearance interval of the log information 302 and calculates a difference of the variance. The difference of the variance is a difference between a minimum variance and a maximum variance.

The extraction unit 114 compares the difference of the mean with a threshold for the mean, and compares the difference of the variance with a threshold for the variance.

When the difference of the mean is equal to or smaller than the threshold for the mean and the difference of the variance is equal to or smaller than the threshold for the variance, the extraction unit 114 decides that the appearance cycle of the log information 302 satisfies the cycle condition.

If the appearance cycle of the log information 302 satisfies the cycle condition, the processing advances to step S3448.

If the appearance cycle of the log information 302 does not satisfy the cycle condition, the processing ends.

In step S3448, the extraction unit 114 adds the appearance cycle of the log information 302 to the common data.

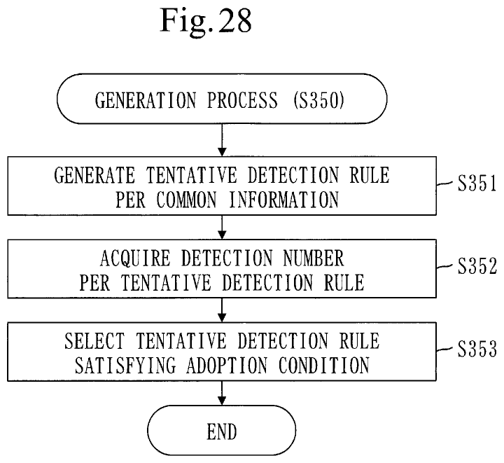

The generation process (S350) will be described with referring to FIG. 28.

In step S351, the generation unit 115 generates a tentative detection rule per set of common information.

Step S351 will be described later in detail.

Step S352 and step S353 are respectively the same as step S152 and step S153 in Embodiment 1 (see FIG. 13).

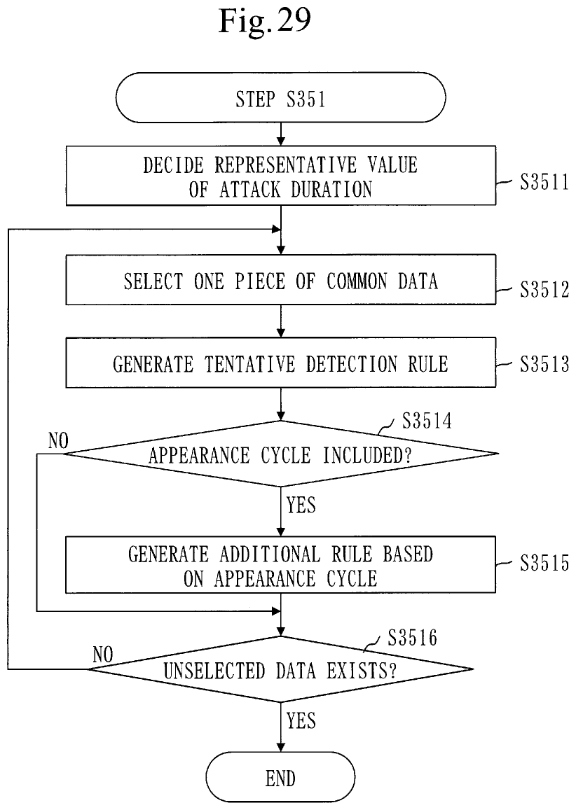

Step S351 will be described with referring to FIG. 29.

Step S3511 to step S3513 are respectively the same as step S1511 to step S1513 in Embodiment 1 (see FIG. 14).

In step S3514, the generation unit 115 checks whether the common data includes an appearance cycle.

If the common data includes an appearance cycle, the processing proceeds to step S3515.

If the common data does not include an appearance cycle, the processing proceeds to step S3516.

In step S3515, the generation unit 115 generates an additional rule based on the appearance cycle.

The additional rule is a rule to be added to a main rule.

The main rule consists of a tentative detection rule and an attack detection rule.

The generation unit 115 generates the additional rule as follows.

The generation unit 115 determines an allowable range of the appearance interval of the log information based on at least either the mean of the attack log data 301 about the appearance cycle of the log information 302, or the variance of the attack log data 301 about the appearance cycle of the log information 302. Then, the generation unit 115 generates a rule including the determined allowable range. The generated rule is the additional rule. The additional rule indicates a condition “the appearance interval of the log information corresponding to the main rule is included in the allowable range”.

Step S3516 is the same as step S1514 in Embodiment 1 (see FIG. 14).

*** Effect of Embodiment 3 ***

When a plurality of pieces of log information including common information have a common cyclicity, a rule about cyclicity information can be added. This enables generation of a tentative detection rule and an attack detection rule that indicate more features of the attacking means.

### Embodiment 4

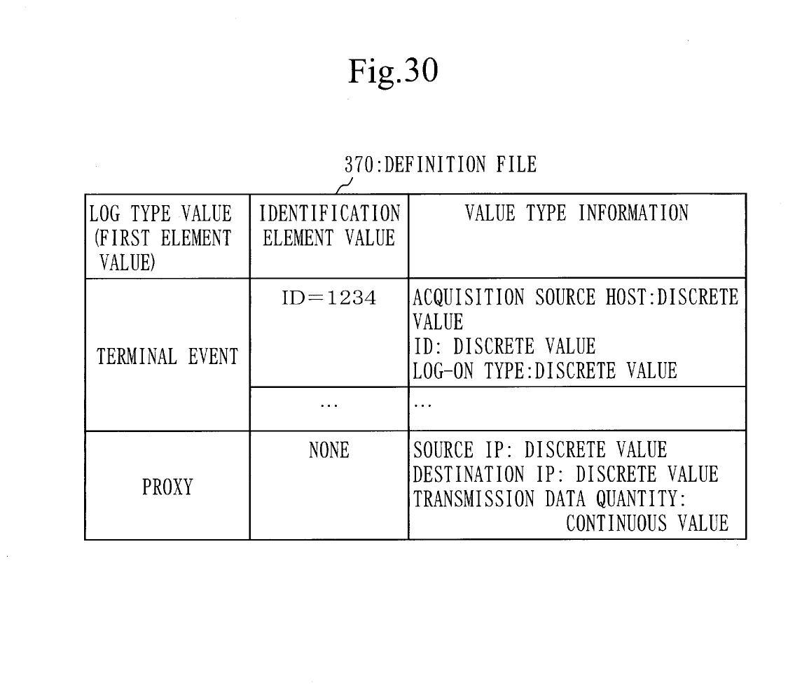

A mode of generating a tentative detection rule based on a statistic value of common information will be described with referring to FIGS. 30 to 36, mainly regarding its difference from Embodiment 1.

*** Description of Configuration ***

A configuration of a rule generation system 200 is the same as the configuration in Embodiment 1 (see FIG. 1).

A configuration of a rule generation apparatus 100 is the same as the configuration in Embodiment 1 (see FIG. 2).

Note that a definition file 370 is stored in a storage unit 120 in advance.

The definition file 370 will be described with referring to FIG. 30.

The definition file 370 illustrates correspondence among a log type value, an identification element value, and value type information.

The log type value is a value of log type. The log type value is equivalent to a first element value.

The identification element value is one of element values included in log information 302.

The value type information indicates a value type of each element.

The value type is a type of each element value included in the log information 302.

Specifically, the value type is a discrete value or a continuous value.

A specific example of the discrete value is a character string. For example, a host name is a character string.

A specific example of the continuous value is a numerical value. For example, a data amount is a continuous value.

*** Description of Operation ***

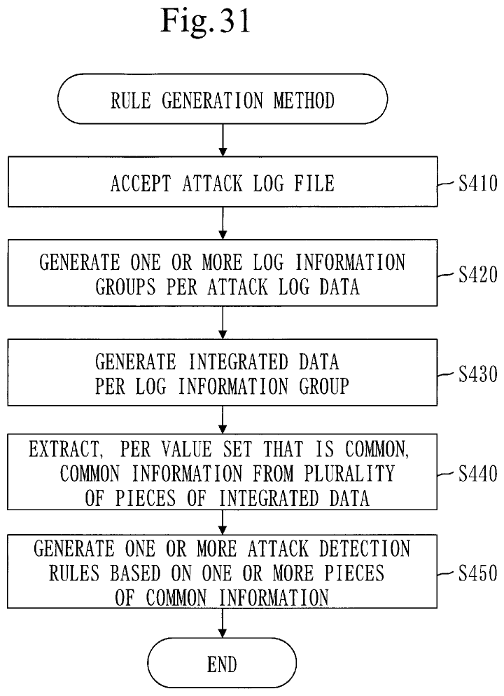

A rule generation method will be described with referring to FIG. 31.

Step S410 and step S420 are respectively the same as step S110 and step S120 in Embodiment 1 (see FIG. 3).

In step S430, an integration unit 113 generates integrated data per log information group.

An integration process (S430) will be described later in detail.

In step S440, an extraction unit 114 extracts, per value set that is common, common information from a plurality of pieces of integrated data.

An extraction process (S440) will be described later in detail.

In step S450, a generation unit 115 generates one or more attack detection rules based on one or more pieces of common information extracted in step S440.

If common information is not extracted in step S450, a feature that is common among the plurality of pieces of attack log data 301 related to the same attacking activity cannot be extracted from the accepted attack log file 300. Hence, the processing of the rule generation method ends.

A generation process (S450) will be described later in detail.

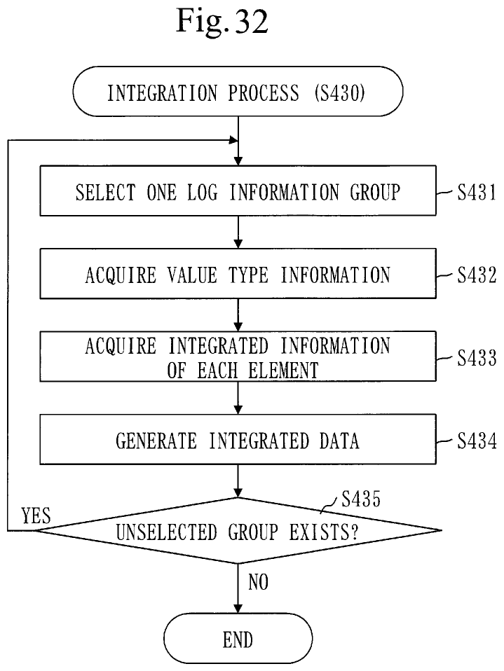

The integration process (S430) will be described with referring to FIG. 32.

In step S431, the integration unit 113 selects one unselected log information group.

Step S432 to step S434 are executed for the sake of the log information group selected in step S431.

In step S432, the integration unit 113 acquires value type information corresponding to a set of the first element value and an identification element value which are included in the log information group, from the definition file 370.

Specifically, the integration unit 113 acquires the set of the first element value and identification element value from the log information group, and acquires the value type information corresponding to the acquired set from a definition file 370.

In step S433, the integration unit 113 acquires integrated information of elements from the log information group based on the value type information.

The integration unit 113 acquires integrated information of an element whose value type is discrete value, as follows.

The integration unit 113 acquires an aggregate of element values from the log information group. Information indicating the aggregate of the element values is the integrated information. The aggregate of the element values consists of 1 or more element values. The aggregate of the element values does not include a plurality of element values of the same value.

For example, the value type of a source IP is discrete value. Assume that the log information group includes three types of source IP: “192.168.1.1”, “192.168.1.2”, and “192.168.1.3”. In this case, the integrated information of the source IP indicates “192.168.1.1”, “192.168.1.2”, and “192.168.1.3”.

The integration unit 113 acquires the integrated information of elements whose value type is continuous value, as follows.

First, the integration unit 113 acquires element values from the log information group. Subsequently, the integration unit 113 divides the acquired one or more element values into groups. Then, the integration unit 113 calculates a statistic value of each element value group. Information that indicates the statistic value of each element value group is the integrated information. A specific example of a method for dividing into groups is cluster analysis. A specific example of the statistic value is mean or variance.

In step S434, the integration unit 113 generates data including integrated information of each element. The data to be generated is the integrated data.

In step S435, the integration unit 113 checks whether an unselected log information group exists. In step S435, an unselected log information group is called unselected group.

If an unselected group exists, the processing proceeds to step S431.

If an unselected group does not exist, the processing ends.

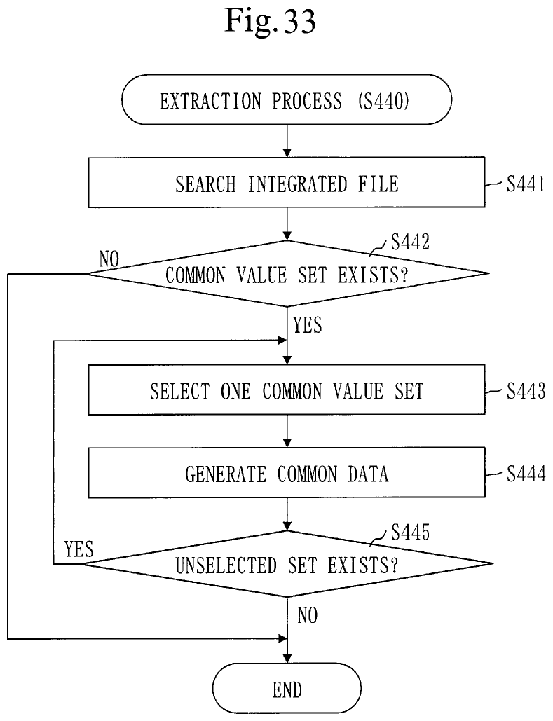

The extraction process (S440) will be described with referring to FIG. 33.

A procedure of step S441 to step S445 is the same as the procedure of step S141 to step S145 in Embodiment 1.

Note that a process of step S441 is different from the process of step S141 in Embodiment 1. Also, a process of step S444 is different from the process of step S144 in Embodiment 1.

In step S441, the extraction unit 114 finds a common value set from an integrated file 330 of pieces of attack log data 301 whose identification element values are equal.

Specifically, the extraction unit 114 compares, among the pieces of attack log data 301, a plurality of values for the elements contained in the integrated file 330. Then, the extraction unit 114 extracts a value that is commonly included in all of the pieces of attack log data 301.

If the type of an element value is discrete value, the extraction unit 114 compares pieces of attack log data 301 with each other to check whether they commonly include the same element value.

If the type of an element value is continuous value, the extraction unit 114 extracts an element whose mean and variance fall within a predetermined range in each piece of attack log data 301.

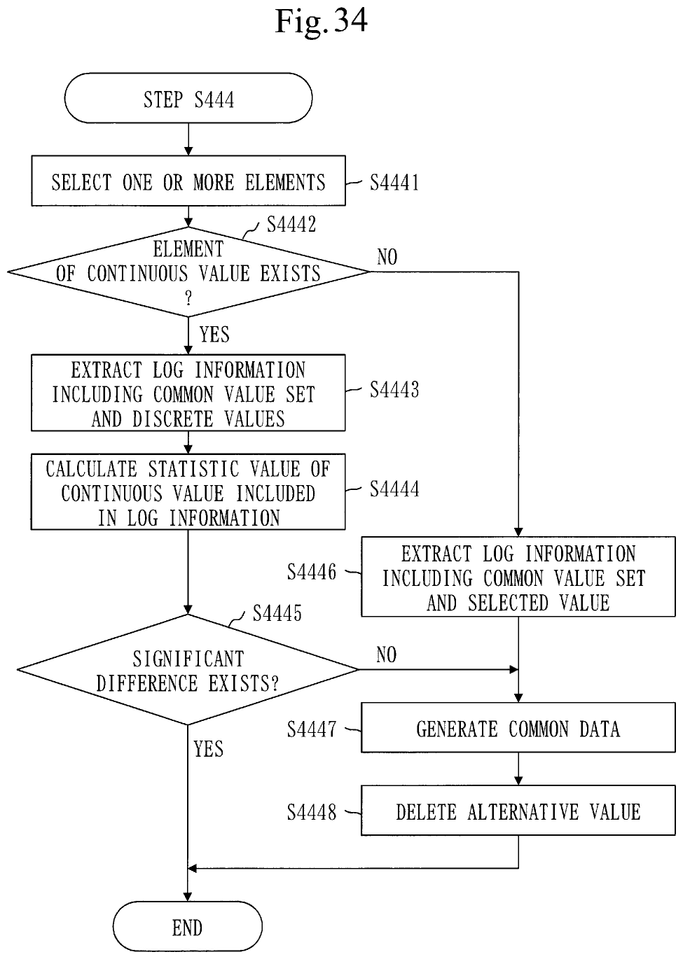

Step S444 will be described with referring to FIG. 34.

In step S4441, the extraction unit 114 selects one or more elements from integrated data corresponding to a common value set.

If a plurality of element values exist for each selected element, the extraction unit 114 selects one or more element values.

When the integrated data indicates “host name=PC_V1, PC_V2, source IP=192.168.1.1, 192.168.1.2, 192.168.1.3”, the extraction unit 114 selects, for example, “host name=PC_V1, source IP=192.168.1.3”

In step S4442, the extraction unit 114 checks whether an element of a continuous value exists in the selected one or more elements.

If an element of a continuous value exists in the selected one or more elements, the processing proceeds to step S4443.

If an element of a continuous value does not exist in the selected one or more elements, the processing proceeds to step S4446.

In step S4443, the extraction unit 114 extracts one or more pieces of log information 302 including a common value set from the log information group.

When an element of a discrete value is included in the one or more elements selected in step S4441, the extraction unit 114 extracts log information 302 including a common value set and the discrete values of the selected element from the log information group.

In step S4444, the extraction unit 114 extracts one or more continuous values from the extracted one or more pieces of log information 302 and calculates a statistic value of the extracted one or more continuous values.

In step S4445, the extraction unit 114 checks whether a significant difference exists between the calculated statistic value and at least any one continuous value of the element selected in step S4441.

If a significant difference exists, the processing ends.

If a significant difference does not exist, the processing proceeds to step S4447.

In step S4446, the extraction unit 114 extracts one or more pieces of log information 302 including common value sets and selected values from the log information group.

The selected values are element values selected in step S4441.

In step S4447, the extraction unit 114 generates data including common value sets, selected values, and a number of times of appearance. The generated data is the common data.

The number of times of appearance is a representative value of a log information number about the log information group extracted in step S4443 or S4446. As described in step S1441 (see FIG. 11) in Embodiment 1, a specific representative value is a minimum log information number.

In step S4448, when an alternative value is included in the common value sets, the extraction unit 114 deletes the alternative value from the common data.

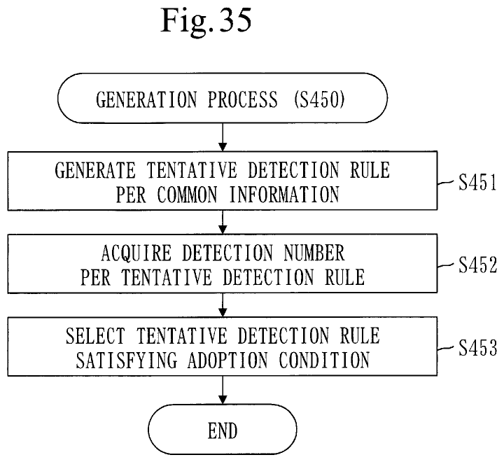

The generation process (S450) will be described with referring to FIG. 35.

In step S451, the generation unit 115 generates a tentative detection rule per common information.

Step S451 will be described later in detail.

Step S452 and step S453 are respectively the same as step S152 and step S153 in Embodiment 1 (see FIG. 13).

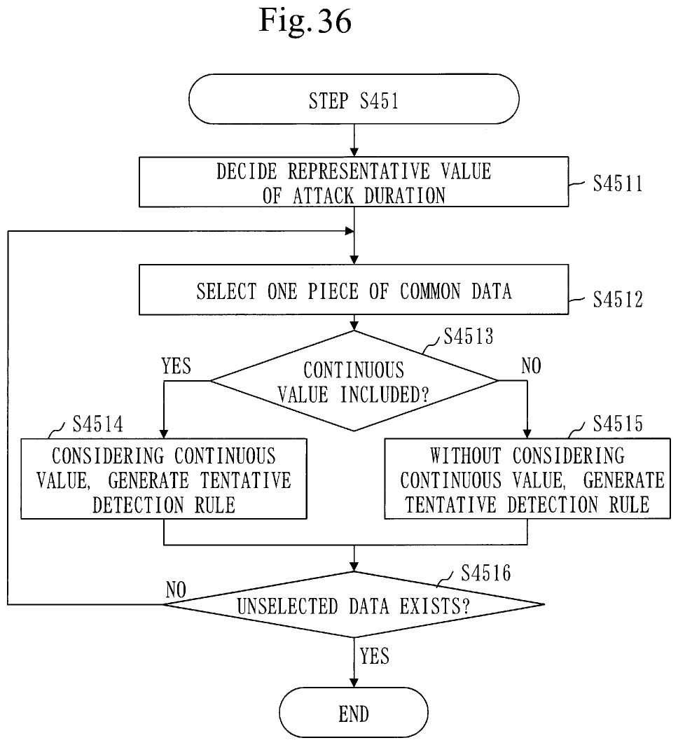

Step S451 will be described with referring to FIG. 36.

Step S4511 and step S4512 are respectively the same as step S1511 and step S1512 in Embodiment 1.

In step S4513, the generation unit 115 checks whether a continuous value is included in the common information in the common data.

If a continuous value is included, the processing proceeds to step S4514.

If a continuous value is not included, the processing proceeds to step S4515.

In step S4514, the generation unit 115 generates a tentative detection rule based on the common data and the representative value of the attack duration, considering the fact that a continuous value is included in the common information in the common data.

For example, the generation unit 115 generates a tentative detection rule “log information including the same value as the discrete value of the common information appears a number of times equal to or more than the number of times of appearance of the common information, within an attack duration (representative value), and an incident where all continuous values of the common information fall within a range of the common information is detected”. The condition regarding the continuous value of the common information may be different. For example, some tolerance may be given to the continuous value of the common information.

In step S4515, the generation unit 115 generates a tentative detection rule, considering the fact that a continuous value is not included in the common information in the common data.

Specifically, the generation unit 115 generates a tentative generation rule according to the same method as the method in step S1513 of Embodiment 1 (see FIG. 14).

In step S4516, the generation unit 115 checks whether unselected common data exists. In step S4516, unselected common data is called unselected data.

If unselected data exists, the processing proceeds to step S4512.

If unselected data does not exist, the processing ends.

*** Effect of Embodiment 4 *** Common information can be generated to include an element other than the classification axis included in the log information. Then, a tentative detection rule and an attack detection rule can be generated based on the common information. Hence, a tentative detection rule and an attack detection rule which indicate more features of the attacking means can be generated.

### Embodiment 5

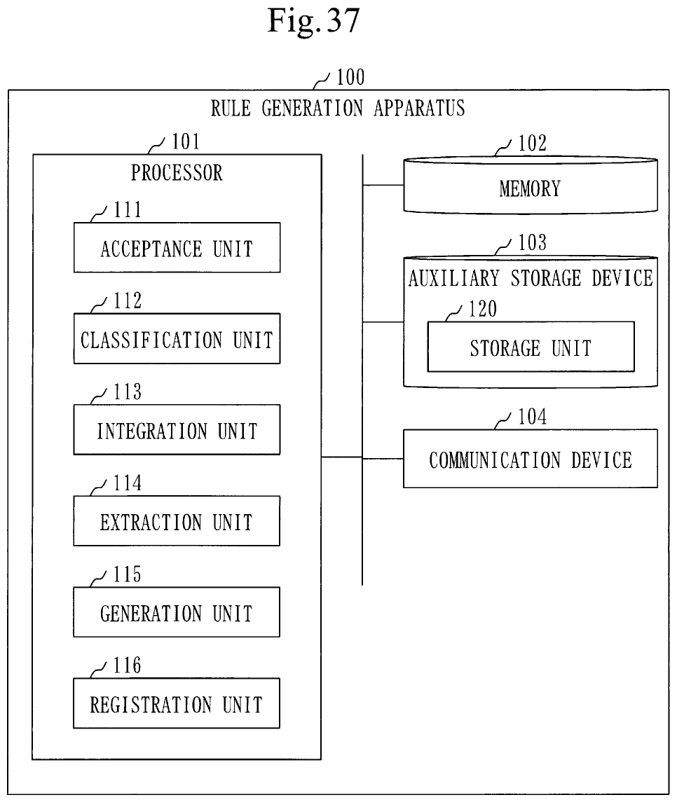

A mode of assisting generation of an alternative value list 320 will be described with referring to FIGS. 37 to 39, mainly regarding its difference from Embodiment 1.

*** Description of Configuration *** A configuration of a rule generation system 200 is the same as the configuration in Embodiment 1 (see FIG. 1).

A configuration of a rule generation apparatus 100 will be described with referring to FIG. 37.

The rule generation apparatus 100 is further provided with an element: a registration unit 116.

A rule generation program further causes a computer to serve as the registration unit 116.

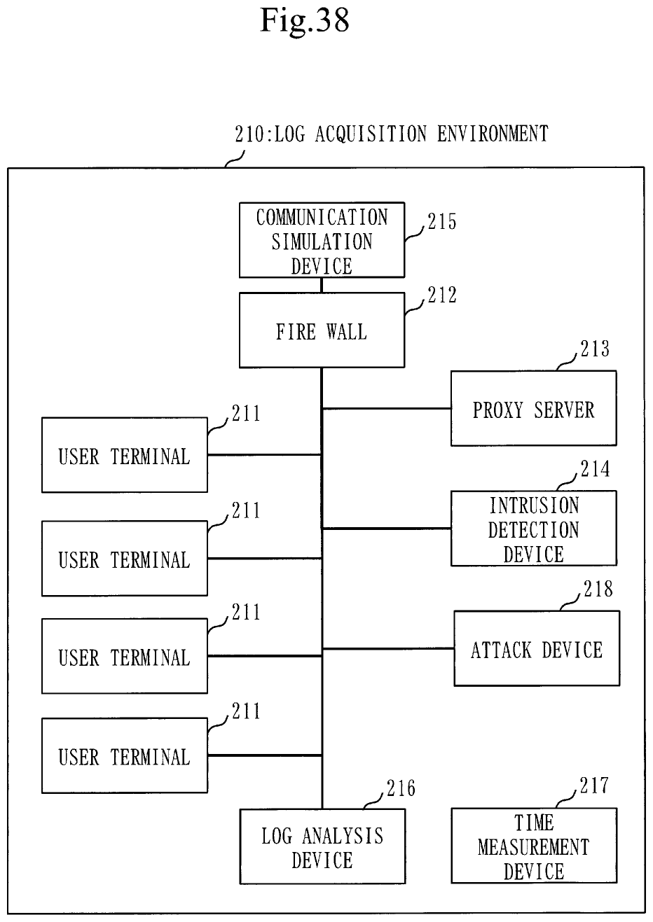

A configuration of an attack execution environment 210 will be described with referring to FIG. 38.

The attack execution environment 210 is further provided with an attack device 218.

The attack device 218 carries out an attacking activity according to an attacking means.

The attack device 218 is capable of recording an operation log. The operation log is log information in which a result of operation is recorded.

The operation log lists specific information concerning an attack such as an attacker and an attack destination. A format of the operation log is given. A value corresponding to an element name to be specified can be acquired from the operation log.

*** Description of Operation ***

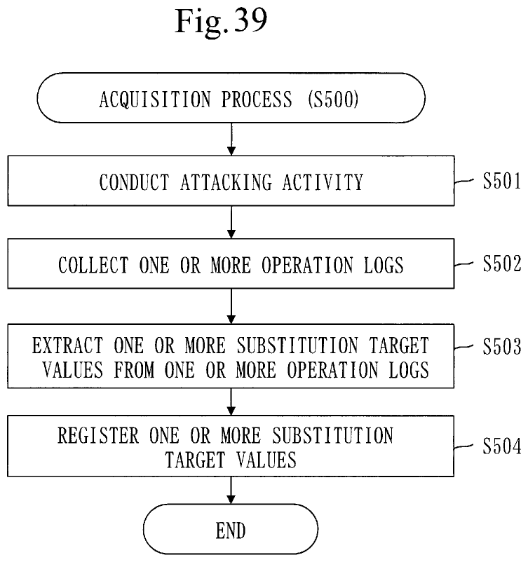

An acquisition process (S500) will be described with referring to FIG. 39.

The acquisition process (S500) is a process for acquiring one or more substitution target values and is executed by the registration unit 116.

In step S501, the registration unit 116 executes an attacking activity corresponding to each attacking means, using the attack device 218.

Specifically, the registration unit 116 requests attack execution of the attack device 218. Then, the attack device 218 executes an attacking activity in accordance with each attacking means.

In step S502, the registration unit 116 acquires, from the attack device 218, one or more operation logs occurring by execution of the attacking activity.

In step S503, the registration unit 116 extracts one or more substitution target values from the one or more operation logs.

Specifically, the registration unit 116 extracts information described at a specified portion from each operation log. The information to be extracted is the substitution target value. The specified portion is a specific portion in the operation log and is specified based on the log format of the operation log.

In step S504, the registration unit 116 registers one or more substitution target values with the alternative value list 320.

*** Effect of Embodiment 5 ***

One or more substitution target values can be obtained. Therefore, the alternative value list 320 can be created easily. As a result, an effect of reducing a preparation cost necessary for operating the rule generation apparatus 100 can be achieved.

*** Supplement to Embodiments ***

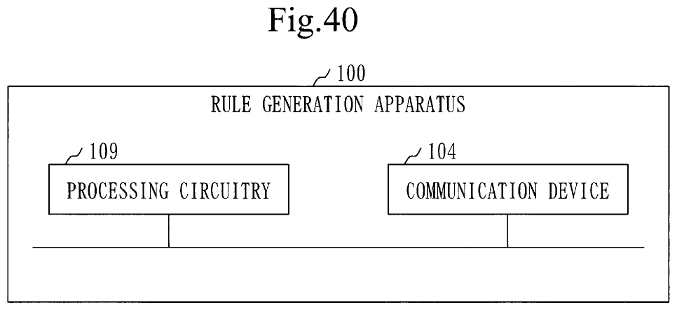

A hardware configuration of the rule generation apparatus 100 will be described with referring to FIG. 40.

The rule generation apparatus 100 is provided with processing circuitry 109.

The processing circuitry 109 is hardware that implements the acceptance unit 111, the classification unit 112, the integration unit 113, the extraction unit 114, the generation unit 115, and the storage unit 120.

The processing circuitry 109 may be dedicated hardware, or the processor 101 which executes the program stored in the memory 102.

In a case where the processing circuitry 109 is dedicated hardware, the processing circuitry 109 is, for example, a single circuit, a composite circuit, a programmed processor, a parallel-programmed processor, an ASIC, or an FPGA; or a combination of them.

Note that ASIC stands for Application Specific Integrated Circuit, and FPGA stands for Field Programmable Gate Array.

The rule generation apparatus 100 may be provided with a plurality of processing circuitries that substitute for the processing circuitry 109. The plurality of processing circuitries share the role of the processing circuitry 109.

In the processing circuitry 109, some of the functions may be implemented by dedicated hardware, and the remaining functions may be implemented by software or firmware.

In this manner, the processing circuitry 109 can be implemented by hardware, software, or firmware; or a combination of them.

The embodiments are exemplifications of preferred modes, and are not intended to limit the technical scope of the present invention. Each embodiment may be practiced partially, or practiced in combination with another embodiment. The procedures described with using the flowcharts or the like may be change as necessary.

### REFERENCE SIGNS LIST

100: rule generation apparatus; 101: processor; 102: memory; 103: auxiliary storage device; 104: communication device; 109: processing circuitry; 111: acceptance unit; 112: classification unit; 113: integration unit; 114: extraction unit; 115: generation unit; 116: registration unit; 120: storage unit; 200: rule generation system; 210: attack execution environment; 211: user terminal; 212: fire wall; 213: proxy server; 214: intrusion detection device; 215: communication simulation device; 216: log analysis device; 217: time measurement device; 218: attack device; 220: log analysis device; 300: attack log file; 301: attack log data; 302: log information; 310: second element list; 320: alternative value list; 330: integrated file; 340: common file; 350: tentative detection rule file; 360: analysis result file; 370: definition file.

1. A rule generation apparatus comprising:
processing circuitry
to classify, per attack log data of a plurality of pieces of attack log data, one or more pieces of log information included in the attack log data, by value set consisting of a value of a first element and a value of a second element, thereby generating one or more log information groups,
to integrate, per log information group, one or more pieces of log information included in the log information group, thereby generating integrated data,
to extract, per value set, in one or more value sets, that is common among the plurality of pieces of attack log data, common information from a plurality of pieces of integrated data corresponding to the plurality of pieces of attack log data, and
to generate one or more attack detection rules based on one or more pieces of common information.

2. The rule generation apparatus according to claim 1, wherein the processing circuitry counts a log information number, being a number of pieces of log information included in the log information group, and includes the log information number into the integrated data.

3. The rule generation apparatus according to claim 2,
wherein the processing circuitry
decides a representative value of the log information number based on a plurality of log information numbers included in the plurality of pieces of integrated data, and generates common data including the common information and the representative value of the log information number, and
generates one or more attack detection rules based on one or more pieces of common data.

4. The rule generation apparatus according to claim 1,
wherein the processing circuitry substitutes a substitution target value included in each piece of integrated data by an alternative value.

5. The rule generation apparatus according to claim 4,
wherein, if the alternative value is included in the common information, the processing circuitry deletes the alternative value from the common information, or changes the alternative value to an arbitrary value.

6. The rule generation apparatus according to claim 1,
wherein the processing circuitry generates, per common information, a tentative detection rule based on the common information, acquires, per tentative detection rule, a detection number being a number of times an incident that meets the tentative detection rule is detected, and selects a tentative detection rule that corresponds to a detection number satisfying an adoption condition, as the attack detection rule.

7. The rule generation apparatus according to claim 1,
wherein the processing circuitry generates, per set of common information, a tentative detection rule based on the common information, acquires, per tentative detection rule, a detection number being a number of times an incident that meets the tentative detection rule is detected, and selects a tentative detection rule that corresponds to a detection number satisfying an adoption condition, as the attack detection rule.

8. The rule generation apparatus according to claim 1,
wherein each piece of log information includes an appearance time point,
wherein the processing circuitry, per attack log data, calculates an appearance interval of the log information based on an appearance time point of each log information, and generates common data including the common information and the appearance cycle, and
wherein the processing circuitry generates one or more attack detection rules based on one or more pieces of common information.

9. The rule generation apparatus according to claim 1,
wherein the processing circuitry acquires value type information corresponding to a set of a first element value and an identification element value which are included in the log information group, from a definition file which makes correspondence between the set of the first element value and the identification element value with the value type information indicating a value type of each element, acquires integrated information of each element from the log information group based on the acquired value type information, and generates the integrated data including the integrated information of the elements.

10. The rule generation apparatus according to claim 1,
wherein the processing circuitry extracts a substitution target value listed at a specified portion from each of the one or more pieces of log information obtained in a log acquisition environment, and registers each extracted substitution target value with an alternate value list which makes correspondence between one or more alternative values and one or more substitution target values, and
wherein, when a second element value included in the integrated data coincides with a substitution target value included in the alternative value list, the processing circuitry acquires an alternative value that corresponds to the substitution target value coinciding with the second element value, from the alternative value list, and substitutes the second element value included in the integrated data by the acquired alternative value.

11. A non-transitory computer readable medium storing a rule generation program which causes a computer to execute:
a classification process of classifying, per attack log data of a plurality of pieces of attack log data, one or more pieces of log information included in the attack log data, by value set consisting of a value of a first element and a value of a second element, thereby generating one or more log information groups;
an integration process of integrating, per log information group, one or more pieces of log information included in the log information group, thereby generating integrated data;
